(19) United States
(12) Patent Application Publication
(10) Pub. No.: US 2025/0108629 A1
(43) Pub. Date: Apr. 3, 2025

(54) SYSTEM TO PROVIDE A PREDETERMINED SPACE BETWEEN CYLINDRICAL INK-TRANSFERRING COMPONENTS OF A DECORATOR

(71) Applicant: Ball Corporation, Westminster, CO (US)

(72) Inventors: Kyle Barras, Lakewood, CO (US); John Efner, Surprise, AZ (US); Kaitlyn M. Bock, Lakewood, CO (US)

(73) Assignee: Ball Corporation, Westminster, CO (US)

(21) Appl. No.: 18/899,132

(22) Filed: Sep. 27, 2024

Related U.S. Application Data
(60) Provisional application No. 63/541,669, filed on Sep. 29, 2023.

(51) Int. Cl. B41J 3/407; B41J 13/02

(52) U.S. Cl. CPC B41J 3/40733; B41J 13/02

(57) ABSTRACT

An apparatus and methods of decorating exterior surfaces of metallic containers are provided. The present disclosure provides a novel decorator with spacers that define a first gap between a blanket wheel and an adjacent plate cylinder. The decorator may also include a spacer on a form roller to define a second gap between the plate cylinder and a form roller. The gaps facilitate a transfer of a precise amount of ink from a printing plate on the plate cylinder to a transfer blanket on the blanket wheel. The spacers also facilitate control of the pressures between the form roller and the plate cylinder, and between the plate cylinder and the transfer blanket.

### CROSS REFERENCE TO RELATED APPLICATIONS

This application claims priority and benefits under 35 U.S.C. § 119 (e) to U.S. Provisional Patent Application Ser. No. 63/541,669 filed on Sep. 29, 2023, which is incorporated herein in its entirety by reference.

### FIELD

The present disclosure relates generally to decorators and methods of decorating exterior surfaces of metallic containers used to package food, beverages, and other products. More specifically, the present disclosure provides novel “bearer strips” or spacers that define a predetermined space (or a gap) between cylindrical components of a decorator which is configured to decorate generally cylindrical surfaces of metallic containers.

### BACKGROUND

Metallic containers provide many benefits compared to containers made of glass or plastic. Many consumers and distributors prefer metallic containers due to the convenience they offer and their light weight. The cylindrical surfaces of metallic containers are also ideal for decorating with brand names, logos, designs, product information, and other preferred indicia for identification, marketing, and distinguishing brands between competitors. Because of these and other benefits, hundreds of billions of metallic containers are produced globally each year.

To meet the global demand for metallic containers, equipment in metallic container manufacturing lines, including decorators, must operate at very high speeds. In some manufacturing lines, decorators can decorate 500 or more metallic containers per minute. Some decorators can decorate 2,400 metallic container per minute. Because of the high speeds of container production lines, techniques or processes that may work in other industries or with containers formed of other materials do not necessarily work at the high speeds required for metallic container production lines. For example, apparatus and methods of decorating sheets or webs of paper and cardboard materials are distinct from decorators used for 3-dimensional objects, such as metallic containers. Decorators used to decorate sheets or webs of paper typically use a lithographic process. In contrast, decorators used in the metallic container industry include printing plates and use a flexographic printing process. Further, inks used to adhere to metallic containers have different properties than inks used to print on paper or plastics. For example, rheology and pigment size of ink used to decorate metallic containers are typically different than in inks used to print on paper or plastic, and ink used on metallic containers may also include adhesion promoters. Accordingly, specialized or different equipment and techniques are often required for many of the operations used to form and decorate metallic containers compared to those used to print on paper or plastics.

Metallic containers are frequently decorated with an image or indicia, such as a brand name, logo, product information, or design by a lithographic or dry off-set printing process. Examples of printing methods and apparatus for decorating metallic containers are described in U.S. Pat. Nos. 3,960,073; 4,384,518; 5,233,922; 6,550,389; 6,899,998; 9,475,276; 9,573,358, 9,884,478; 10,976,263; 11,383,509; U.S. Patent App. Pub. No. 2009/0128590; U.S. Patent App. Pub. No. 2012/0272846; U.S. Patent App. Pub. No. 2014/0360394; U.S. Patent App. Pub. 2014/0373741; U.S. Patent App. Pub. No. 2015/0183211; U.S. Patent App. Pub. No. 2015/0128819; U.S. Patent App. Pub. No. 2015/0217559; U.S. Patent App. Pub. No. 2015/0128821; U.S. Patent App. Pub. No. 2016/0229198; U.S. Patent App. Pub. No. 2017/0008270; U.S. Patent App. Pub. No. 2018/0126724; U.S. Patent App. Pub. No. 2022/0410555; WIPO Publication No. WO 2014/006517; WIPO Publication No. WO 2014/008544; WIPO Publication No. WO 2013/113616; WIPO Publication No. WO 2014/108489; and WIPO Publication No. WO 2014/128200 each of which are each incorporated herein by reference in their entireties.

Referring now to FIGS. 1 and 2, a prior art decorator 2 is generally illustrated. The decorator 2 includes an infeed conveyor 4A which receives undecorated metallic containers 6A and directs them to a support cylinder 8. The support cylinder includes pockets with mandrels that receive the metallic containers. When positioned on the mandrels, the metallic containers 6 are decorated by being brought into contact with a transfer blanket 12 on a blanket wheel or cylinder 10. The transfer blankets 12 transfer ink images to the metallic containers 6.

The transfer blankets 12 receive the ink image from printing plates 16 positioned on plate cylinders 14. A decorator 2 can have a plurality of plate cylinders 14 that each have an associated inking assembly 18. For example, decorators used to decorate metallic containers 6 frequently have from four to nine plate cylinders 14 which each have an associated inking assembly 18. Each inking assembly 18 transfers a single color of ink to the printing plate 16 of a single associated plate cylinder 14. When ink has been transferred from a printing plate 16 of each plate cylinder to a transfer blanket 12, the final lithographic ink image is formed on the transfer blanket 12. For example, if the decorator 2 includes six plate cylinders 14, a printing plate 16 of each of the six plate cylinders may transfer ink to a single transfer blanket 12 to form the lithographic image with six different inks.

After receiving an ink image from a transfer blanket 12, the decorated metallic containers 6B can receive a protective coating from a varnish unit 42. The varnish unit 42 may include a roller to apply the protective coating to the exterior surfaces of the metallic containers. The decorated metallic containers 6B are then transported from the decorator 2 by an out-feed conveyor 4B (illustrated in FIG. 2), such as a pin chain.

Referring now to FIG. 2, a schematic view of a prior art inking assembly 18 is shown. Examples of prior art inking assemblies are described in U.S. Pat. No. 9,475,276, U.S. Pat. App. Pub. 2014/0373741, U.S. Pat. App. Pub. 2015/0128819, U.S. Pat. App. Pub. 2017/0008270, and U.S. Pat. App. Pub. 2018/0126724 which are each incorporated herein in their entirety by reference.

The exemplary inking assembly 18 includes a number of rollers 24, 26, 28, 30, 32, 34, 36, 38, 40 that transfer ink 22 from an ink fountain 20 to a printing plate 16 on a plate cylinder 14. The printing plate 16 can then transfer the ink 22 to a transfer blanket 12 on the blanket wheel 10 of the decorator 2. As generally illustrated in FIG. 2, the blanket wheel 10 typically includes a number of individual segments 11 that are separated from one another by gaps in the circumference of the blanket wheel. Each segment 11 includes a single transfer blanket 12.

Inking assemblies 18 typically include a fountain or ink roller 24 that picks up ink 22 from the ink fountain 20. The amount or thickness of ink picked up by the ink roller 24 is controlled by ink keys or blades (not illustrated) spaced along an axis of the ink roller 24.

Some decorators include a ductor roller 26 which receives ink 22 from the ink roller 24. In operation, the ductor roller 26 pivots or oscillates at high speed between two positions in which the ductor roller is alternately in direct contact with one of the ink roller 24 and a transfer roller 28. In a first position the ductor roller 26 is in contact with the ink roller 24. In a second position the ductor roller 26 is in contact with the transfer roller 28. The ductor roller 26 is only in contact with one of the ink roller 24 and the transfer roller 28 at any given time. In some prior art inking assemblies 18, the ductor roller 26 may move from the first position to the second position at up to 20 or 30 oscillations per minute.

The ductor roller 26 transfers ink to a transfer roller 28. The amount of ink transferred from the ductor roller 26 to the transfer roller 28 may be adjusted by altering the operation of the ductor roller 26, such as by altering the amount of time the ductor roller is in the first position in contact with the ink roller 24 (known as the “dwell time”).

The transfer roller 28 subsequently transfers the ink to additional downstream rollers. The number of downstream rollers and the types (or functions) of downstream rollers may vary, but some decorators 2 and inking assemblies 18 include a second transfer roller 30, a first oscillator roller 32, a third transfer roller 34, a fourth transfer roller 36, a second oscillator roller 38, and one or two form rollers 40. In the ink assembly 18 illustrated in FIG. 2, a first form roller 40A and a second form roller 40B transfer the ink 22 to specific areas of the printing plate 16 on the plate cylinder 14. More specifically, in some printing methods, the printing plate 16 includes a portion of an image defined by raised surfaces. The raised surfaces of the printing plate 16 receive ink from the form roller 40A (or form rollers 40A, 40B). Metallic containers may be decorated by other known printing methods that use different techniques to form an ink image on a printing plate.

The ink is subsequently transferred to a transfer blanket 12 as an ink image which is then transferred to the exterior surface of the metallic container 6. The number of downstream rollers and their positions and functions may vary in prior art decorators.

Producing acceptable decorations on metallic containers 6 with prior art decorators 2 is dependent upon the skill and attentiveness of the operator and requires considerable labor and associated expense. Adjusting the settings and alignment of the rotating rollers (10, 14, 24, 26, 28, 30, 32, 34, 36, 38, 40) in a prior art decorator 2 to correctly transfer an acceptable amount of ink 22 to the printing plates 16 and transfer blankets 12 is challenging. Although it is possible to measure distances between the rollers to check their alignment, taking these measurements is difficult, time consuming and results in an unacceptable amount of down time. Operators are often left to guessing or trial and error when adjusting components of the decorator 2 (and its inking assemblies 18) before arriving at settings that produce an acceptable ink transfer to the printing plate 16. If the settings are incorrect, an excessive (or insufficient) amount of ink may be transferred to the printing plate (or a portion of the printing plate) resulting in a deficient decoration. As will be appreciated by one of skill in the art, deficient decorations result in rejected metallic containers wasting money. Further, the difficulty in setting up the decorator 2 for a decoration run with a new label results in a significant amount of down time and lost revenue each day.

More specifically, for each decoration run to decorate metallic containers with a new decoration (or label), the decorator 2 must be set up to produce a new decoration. Setting up the decorator is a task that requires skill and is dependent on the experience of the operator.

To set up the decorator, the operator must position new printing plates 16 on each of the plate cylinders 14. This requires removal of the plate cylinder 14 of each inking assembly 18. Once the new printing plate 16 is on a plate cylinder 14, it must be reinstalled in the inking assembly 18.

Ink from the previous decoration run must typically be removed before the new decoration run can begin. The operator may change the ink when removing the old printing plate 16 and/or plate cylinder 14 and installing the new printing plate and/or plate cylinder. To change the ink, one or more of the rollers or cylinders 10, 14, 26, 28, 30, 32, 34, 36, 38, and 40 may need to be separated and cleaned. In contrast, some decorators used to decorate continuous webs of paper may not require disassembly to clean out old ink between decorator runs.

The inking assemblies 18 associated with each of the plate cylinders 14 must then be adjusted to transfer the correct amount of ink 22 to their associated printing plates 16. This can include adjusting ink keys or ink blades of the ink fountains 20, adjusting the cycle time and the dwell time for the ductor roller 26, and setting or adjusting the distance and/or pressure between pairs of rollers or cylinders 10, 14, 26, 28, 30, 32, 34, 36, 38, and 40. The distance between the form roller 40 and the plate cylinder 14 and between the plate cylinder 14 and the blanket wheel 10 are particularly important. As will be appreciated by one of skill in the art, the distance between the form rollers 40 and the plate cylinder 14 and between the plate cylinder 14 and blanket wheel 10 control the pressure between these components of the decorator.

Referring now to FIG. 3A, a schematic front elevation view of a plate cylinder 14 and a form roller 40 of the prior art decorator 2 are generally illustrated. The form roller 40 rotates on an axle 46 that is supported at both ends of the form roller by a frame 44 of the inking assembly 18. In contrast, the plate cylinder 14 rotates on an axle 48 which is only supported at one end of the plate cylinder by the frame 44. Supporting only one end of the axle 48 of the plate cylinder facilitates removal of the plate cylinder 14 from the inking assembly 18 in the direction of arrow 52.

When properly set up, the cylindrical surface of the plate cylinder 14 should be approximately parallel to the cylindrical surface of the form roller 40 as generally illustrated in FIG. 3A. However, the current process for properly aligning and setting the pressure between pairs of rotating cylinders and rollers (such as the plate cylinder 14 and the form roller 40, or between the plate cylinder 14 and the blanket wheel 10) is visual and entirely subject to an operator's judgement. One training manual instructs the operator to shine a light behind the rollers and look for light between the plate cylinder and the form roller to determine if the rollers are properly aligned. As will be appreciated by one of skill in the art, the gap 50 between the plate cylinder 14 and the form roller 40 is typically less than 0.04 inches making visual inspection and alignment difficult. Due to the difficulty of adjusting the positions of adjacent rollers and cylinders, the cylindrical surfaces are frequently not parallel at the beginning of a production run due to incorrect set up and adjustment by the operator.

If the cylindrical surfaces of the plate cylinder 14 and the form roller 40 are not parallel, the printing plate 16 will not receive the proper amount of ink. For example, when the axle 46 of the form roller 40 is not parallel to the axle 48 of the plate cylinder 14 (as shown in FIG. 3B), too much ink 22 will be applied to one side of the printing plate 16 where the gap 50A is too small. Too little (or no) ink 22 will be applied to an opposite side of the printing plate 16 where the gap 50B is too great. Even if the plate cylinder 14 and the form roller 40 are approximately parallel to one another at the beginning of a decoration run (as shown in FIG. 3A), one (or both) of the plate cylinder and the form roller may drift out of alignment during the decoration run due to vibrations, heat, or worn parts.

A similar problem occurs when the cylindrical surfaces of the plate cylinder 14 and the blanket wheel 10 are not parallel. More specifically, when the adjacent surfaces of the plate cylinder and the blanket wheel are not parallel, ink 22 may be applied unevenly to portions of the transfer blankets 12.

The operators must also properly set the pressure between the rollers and cylinders. Adjusting the pressures to transfer the necessary amount of ink can take a significant amount of time during which the decorator 2 is out of production. Operators tend to set the pressure between the pairs of rotating rollers based on their own preferences. The lack of uniformity can cause problems as operators attempt to set up a decorator for a decoration run. Currently, as ink is being transferred from a form roller 40 in one of the decorator's inking assemblies 18 to the surface of a printing plate 16 during the dry-offset flexographic printing process, much skill and attention must be given to ensure correct application of pressure between the form roller 40 and the printing plate 16 and between the printing plate 16 and the transfer blanket 12.

Incorrect amounts of pressure between the rollers (a form roller 40 and the plate cylinder 14, or the plate cylinder 14 and the blanket wheel 10) may cause problems. Too little pressure between form roller 40 and the plate cylinder 14 will result in an insufficient amount of ink transfer to the image on the printing plate 16. This results in an inadequate amount of ink 22 being applied to the metallic container 6 and may result in a deficient decoration. Additionally, insufficient pressure between the plate cylinder 14 and the blanket wheel 10 leads to insufficient or incomplete ink transfer to the transfer blanket 12 and subsequently to the metallic container.

Alternatively, when too much pressure is applied between the form roller 40 and the plate cylinder 14 and/or between the plate cylinder 14 and the blanket wheel 10, then too much ink is transferred onto the image on the printing plate 16 or the transfer blanket 12. Insufficient pressure (or excessive pressure) can be consistent along the entire length of adjacent rollers or cylinders, or could be only in one spot. The improper pressure may cause a defect in a decoration that is apparent along the entire length (or height of the cylindrical body) of a metallic container, or only at one end of the decoration, such as proximate to the heel (or lower end) of the container. Thus, troubleshooting the cause of a deficient decoration and adjusting the alignment and pressure between adjacent rollers or cylinders to correct the deficient decoration are both very challenging.

In addition, excessive ink on the printing plate 16 often leads to the unintended filling in of low spots on the printing plate. The excess ink in the low spots on the printing plate 16 is frequently transferred to the metallic container and creates undesirable defects in the decoration and waste of ink. Moreover, excessive pressure between the plate cylinder 14 and the blanket wheel 10 increases wear of the printing plate 16 and will also lead to impressions being made in the transfer blankets 12 by the printing plates 16 which causes accelerated wear and aging of the transfer blankets as well a variety of possible defects in the decoration. As will be appreciated by one of skill in the art, replacing worn transfer blankets 12 and printing plates 16 results in a significant amount of downtime of the decorator 2, labor costs for replacing worn transfer blankets and printing plates, equipment costs for new transfer blankets and printing plates, as well as loss of production in the metallic container manufacturing plant. Excessive pressure between rotating components of the decorator may also contribute to artificially shortened lifespans of many components, such as bearings, and increased downtime of the decorator due to maintenance.

These issues and others decrease the efficiency of prior art decorators 2 and waste valuable production time. Because some metallic container production lines may print in excess of 15 different decorations each day, the decorator 2 may be out of production many hours each day during set-up and calibration to prepare the decorator to print different decorations. Considering the high production speeds of up to 2,400 metallic containers per minute at which decorators 2 frequently operate, prior art decorators lose a considerable amount of time and productivity each day during set-up and calibration.

Due to these and other limitations of existing inking assemblies of prior art decorators used to decorate metallic containers, there is an unmet need for an inking assembly that is easier to operate and adjust, which generates less waste, requires less operator time to set up for a decoration run, and is less susceptible to human error than prior art inking assemblies without sacrificing production efficiency or image quality in a high-speed metallic container manufacturing line.

### SUMMARY

These needs, and others, are met by at least one embodiment of the present disclosure.

It is one aspect of the present disclosure to provide a first spacer for a first rotating component of an inking assembly of a decorator, the first spacer configured to engage a second spacer of a second rotating component of the inking assembly. In this manner, a first cylindrical surface of the first rotating component is spaced from a second cylindrical surface of the second rotating component by a gap with a predetermined magnitude.

In at least one embodiment, the first rotating component is a form roller and the second rotating component is a plate cylinder. Alternatively, in other embodiments, the first rotating component is a plate cylinder and the second rotating component is a blanket wheel of the decorator.

In some embodiments, the magnitude of the gap is between about 0.01 and about 0.2 inches. In at least one embodiment, the magnitude of the gap is between about 0.01 and about 0.04 inches. In other embodiments, the magnitude of the gap is between about 0.012 and about 0.036 inches. Optionally, in at least one embodiment, the magnitude of the gap is between about 0.013 and about 0.035 inches. In some embodiments, the magnitude of the gap is not less than 0.028 inches.

In some embodiments, the first and second spacers are both generally circular. The spacers may be described as generally disc shaped. Additionally, or alternatively, one or more of the spacers may be a ring. In at least one embodiment, a spacer associated with the blanket wheel is a ring. A spacer formed of a ring may beneficially reduce the mass of the spacer.

One or more of the spacers may be formed of multiple portions or sections. Optionally, a spacer may comprise two to ten separate sections. For example, a spacer may have two, three, four, five, six, seven, eight, nine or ten sections that form a bearing surface. In some embodiments, the sections may move relative to one another to alter a size or diameter of a spacer.

The spacers have a thickness measured in an axial dimension and a spacer diameter measured in a radial dimension orthogonal to the axial dimension. In some embodiments, the spacer diameter is at least five times greater than the spacer thickness.

The first spacer has a first bearing surface. The second spacer has a second bearing surface configured to engage the first bearing surface of the first spacer.

The first and second bearing surfaces are substantially cylindrical. For example, the first and second bearing surfaces may have an eccentricity of approximately 0. In at least one embodiment, one or more of the first and second bearing surfaces has an eccentricity of from 0 to 0.1. In some embodiments, one or more of the first and second bearing surfaces has an eccentricity of from 0 to 0.01. In other embodiments, one or more of the first and second bearing surfaces has an eccentricity of from 0 to 0.005.

In at least one embodiment, one or more of the first or second bearing surfaces is substantially uniform or continuous. More specifically, one or more of the first and second bearing surfaces may be devoid of gaps or breaks. In this manner bearing surfaces of adjacent spacers may engage one another and provide a substantially constant gap between associated rotating components of the decorator. Further, spacers formed with substantially uniform bearing surfaces may beneficially reduce inadvertent movement or vibration of an associated rotating component.

In at least one embodiment, the first bearing surface is oriented approximately parallel to the axial dimension. In this embodiment, the second bearing surface is also oriented approximately parallel to the axial dimension.

Alternatively, in at least one embodiment, the first bearing surface has a first shape and the second bearing surface has a second shape. In some embodiments the first shape may be described as being keyed to the second shape. Additionally, or alternatively, the first shape may be the inverse of the second shape.

In some embodiments, the first shape is concave when the first bearing surface is viewed in a cross-section of a first spacer taken along a vertical plane extending in the axial dimension and the radial dimension, the vertical plane oriented parallel to a first axis of rotation of the first spacer. In these embodiments, the second shape of the second bearing surface is convex when viewed in a cross-section of the second spacer taken along the vertical plane.

Optionally, the first shape is rounded or “U-shaped” when the first bearing surface is viewed in the cross-section. Alternatively, the first shape is “V-shaped” when viewed in the cross-section.

In some embodiments, the first bearing surface has a first projection which extends from the first bearing surface in the radial dimension. In these embodiments, the second bearing surface has a circumferential groove or depression configured to receive the first projection.

In one or more embodiment, at least one of the first bearing surface and the second bearing surface is configured such that the predetermined distance between the first rotating component and the second rotating component is adjustable.

Optionally, in some embodiments, the first bearing surface of the first spacer may include a first projection. In these embodiments, the second bearing surface has a recess (such as a circumferential groove or depression) to at least partially receive the first projection. In some embodiments, the recess has a depth that is greater than a height of the first projection.

The spacers are formed of a dimensionally stable material. In some embodiments, one or more of the spacers is formed of a metal, a ceramic, a polymeric material (such as nylon, plastic), and combinations thereof. In some embodiments, the spacers are formed of a steel.

The first cylindrical surface of the first rotating component has a first diameter. The bearing surface of the first spacer has a first spacer diameter. Optionally, the first spacer diameter is approximately equal to the first diameter.

In some embodiments, the first spacer diameter is different than the first diameter. In at least one embodiment, the first spacer diameter is at least about 0.005 inches different than the first diameter.

In at least one embodiment, the first spacer diameter is greater than the first diameter. Alternatively, in other embodiments, the first spacer diameter is less than the first diameter.

Another aspect of the disclosure is a decorator configured to decorate an exterior surface of a metallic container. The decorator comprises: (1) an inking assembly, comprising: (a) an ink fountain configured to provide a supply of ink; (b) an ink roller to receive ink from the ink fountain; (c) an ink train comprising a plurality of cylindrical rollers to transfer ink from the ink roller to a form roller; and (d) a plate cylinder comprising a printing plate with a decoration adapted to receive ink from the form roller, the plate cylinder further comprising a first spacer with a first bearing surface; and (2) a blanket wheel comprising a transfer blanket adapted to receive ink from the printing plate, the blanket wheel further comprising a second spacer with a second bearing surface selectively engageable with the first bearing surface of the first spacer, wherein the first and second spacers set a distance between the plate cylinder and the blanket wheel.

In some embodiments, the form roller optionally comprises a third spacer with a third bearing surface selectively engageable with the first bearing surface of the first spacer of the plate cylinder.

In at least one embodiment, the first and third spacers set a distance between the form roller and the plate cylinder.

The decorator optionally includes one or more of the previous embodiments, and in some embodiments the plate cylinder comprises a first cylindrical body with a first diameter and the first bearing surface of the first spacer has a first spacer diameter. In at least one embodiment, the first spacer diameter is less than the first diameter. Alternatively, in other embodiments, the first spacer diameter is equal to the first diameter. In still other embodiments, the first spacer diameter is greater than the first diameter.

The decorator may include one or more of the previous embodiments, and in some embodiments the blanket wheel comprises a second diameter and the second bearing surface of the second spacer has a second spacer diameter. In some embodiments, the second spacer diameter is less than the second diameter. In other embodiments, the second spacer diameter is equal to the second diameter. Alternatively, in still other embodiments, the second spacer diameter is greater than the second diameter.

The decorator optionally includes one or more of the previous embodiments, and in at least one embodiment the first spacer diameter is greater than the first diameter and the second spacer diameter is greater than the second diameter.

In some embodiments, the first spacer diameter is greater than the first diameter and the second spacer diameter is less than the second diameter.

Alternatively, in other embodiments, the first spacer diameter is less than the first diameter and the second spacer diameter is greater than the second diameter.

The decorator optionally includes one or more of the previous embodiments, and contact of the first bearing surface with the second bearing surface creates a first gap between a first cylindrical body of the plate cylinder and a second cylindrical body of the blanket wheel. Optionally, the first gap has a first magnitude of between about 0.01 and about 0.2 inches.

In at least one embodiment, the first magnitude of the first gap is adjustable.

The decorator optionally includes one or more of the previous embodiments, and optionally one or more of the first spacer and the second spacer are removably affixed to the associated plate cylinder and blanket wheel.

In some embodiments, a replacement first spacer and a replacement second spacer are attachable to the plate cylinder and the blanket wheel to alter the first magnitude of the first gap.

The decorator optionally includes one or more of the previous embodiments, and the form roller optionally comprises a third spacer with a third bearing surface selectively engageable with the first bearing surface of the first spacer of the plate cylinder. In these embodiments, contact of the third bearing surface with the first bearing surface creates a second gap between a third cylindrical body of the form roller and the first cylindrical body of the plate cylinder

In at least one embodiment, the second gap has a second magnitude of between about 0.01 and about 0.2 inches.

The decorator optionally includes one or more of the previous embodiments, and optionally one or more of the first spacer and the second spacer is an adjustable spacer with a diameter that is variable.

In some embodiments, in a first state the adjustable spacer has a first diameter and in a second state the adjustable spacer has a second diameter that is greater than the first diameter.

Optionally, the adjustable spacer is operable to change from the first state to the second state during operation of the decorator.

The decorator optionally includes one or more of the previous embodiments, and in at least one embodiment the first bearing surface and the second bearing surface each have a cross-sectional shape that is substantially uniform (or identical to one another).

Alternatively, in other embodiments, a vertical cross-section of the first bearing surface has a first shape, and a vertical cross-section of the second bearing surface has a second shape that is different than the first shape.

The decorator optionally includes one or more of the previous embodiments, and optionally the first spacer is one of a pair of first spacers associated with the plate cylinder.

In some embodiments, a first one of the pair of first spacers is associated with a first end of a first cylindrical body of the plate cylinder and a second one of the pair of first spacers is associated with a second end of the first cylindrical body of the plate cylinder.

The decorator optionally includes one or more of the previous embodiments, and optionally the second spacer is one of a pair of second spacers associated with the blanket wheel.

In at least one embodiment, a first one of the pair of second spacers is associated with a first end of a second cylindrical body of the blanket wheel and a second one of the pair of second spacers is associated with a second end of the second cylindrical body of the blanket wheel

In some embodiments, the decorator includes one or more of the previous embodiments and the plate cylinder further comprises a first axle

In at least one embodiment the first spacer is immovable relative to the first axle.

The decorator optionally includes one or more of the previous embodiments, and optionally the decorator further comprises a sensor operable to determine one or more of: (a) strain in one or more of the first and second spacers; (b) a rate of rotational movement of one or more of the first and second spacers; (c) vibration of one or more of the first and second spacers; (d) a pressure between the first and second bearing surfaces; (e) a temperature of one or more of the first and second bearing surfaces; and (f) a position of the first spacer relative to a vertical reference plane oriented perpendicular to an axle of the plate cylinder.

In some embodiments, the decorator includes any one or more of the previous embodiments, and optionally further comprises a control system operable to receive data from the sensor.

In embodiments, the control system optionally is further operable to one or more of: (a) send a signal to an actuator to alter the position of the first spacer relative to the vertical reference plane; and/or (b) send a signal to one or more of the first spacer and the second spacer to alter a magnitude of a gap between a first cylindrical body of the plate cylinder and a second cylindrical body of the blanket wheel.

The decorator optionally includes one or more of the previous embodiments, and may further comprise a release mechanism operable to move one or more of the form roller, the plate cylinder, and the blanket wheel to separate one or more of the second and third bearing surfaces from the first bearing surface such that the plate cylinder is removable from the decorator.

It is another aspect to provide a method of controlling one or more of a pressure and a distance between two rotating cylindrical components of a decorator configured to apply a decoration to a cylindrical exterior surface of a metallic container. The method comprises one or more of: (1) providing an inking assembly of the decorator, comprising: (a) a form roller configured to receive ink from an ink fountain; and (b) a plate cylinder comprising: (i) a printing plate adapted to receive ink from the form roller; and (ii) a first spacer with a first bearing surface; (2) providing a blanket wheel of the decorator, the blanket wheel comprising: (a) a transfer blanket adapted to receive ink from the printing plate; and (b) a second spacer with a second bearing surface selectively engageable with the first bearing surface of the first spacer; (3) setting a pressure between the first and second bearing surfaces; (4) transferring ink from the form roller to the printing plate; (5) transferring ink from the printing plate to the transfer blanket; and (6) transferring ink from the transfer blanket to the cylindrical exterior surface of the metallic container.

The method optionally further comprises setting a first magnitude of a first gap between a first cylindrical body of the plate cylinder and a second cylindrical body of the blanket wheel. The first gap is created by contact of the first bearing surface with the second bearing surface.

The method optionally includes one or more of the previous embodiments, and in some embodiments the method further comprises adjusting the first magnitude of the first gap.

In at least one embodiment, the method comprises adjusting the first magnitude of the first gap by one or more of: (a) altering a diameter of the first spacer; (b) altering a diameter of the second spacer; (c) altering a position of the first spacer relative to the first cylindrical body of the plate cylinder; (d) altering a position of the second spacer relative to the second cylindrical body of the blanket wheel; (e) removing the first spacer and replacing it with a different first spacer with a different diameter than the first spacer; and (f) removing the second spacer and replacing it with a different second spacer with a different diameter than the second spacer.

The method optionally includes one or more of the previous embodiments, and optionally further comprises collecting data with a sensor.

In some embodiments, the sensor is operable to determine one or more of: (a) strain in one or more of the first and second spacers; (b) a rate of rotational movement of one or more of the first and second spacers; (c) vibration of one or more of the first and second spacers; (d) a pressure between the first and second bearing surfaces; (e) a temperature of one or more of the first and second bearing surfaces; and (f) a position of one or more of the first spacer and the second spacer relative to a vertical reference plane, the vertical reference plane oriented perpendicular to an axle of the plate cylinder.

The method optionally includes one or more of the previous embodiments, and optionally further comprises moving one or more of the form roller, the plate cylinder, and the blanket wheel to separate one or more of the form roller and the second bearing surface from the first bearing surface such that the plate cylinder is removable from the decorator.

In some embodiments, the method includes one or more of the previous embodiments and further comprises providing a third spacer associated with the form roller, the third spacer comprising a third bearing surface selectively engageable with the first bearing surface of the first spacer.

Still another aspect of the disclosure is an inking assembly for a decorator configured to produce an ink decoration on a cylindrical surface of a metallic container. The inking assembly comprises: (1) a form roller configured to receive ink from an ink fountain; and (2) a plate cylinder, comprising: (a) a first cylindrical body comprising a first end and a second end opposite to the first end; (b) a printing plate affixed to the first cylindrical body, the printing plate comprising a decoration adapted to receive ink from the form roller; and (c) a first spacer interconnected to the plate cylinder proximate to the first end of the first cylindrical body, the first spacer comprising a first bearing surface selectively engageable with a second bearing surface of a second spacer affixed to a blanket wheel of the decorator, such that engagement between the first and second bearing surfaces creates a first gap with a predetermined magnitude between the first cylindrical body and a second cylindrical body of the blanket wheel.

In at least some embodiments, the magnitude of the first gap is between about 0.01 and about 0.2 inches.

The inking assembly optionally includes one or more of the previous embodiments, and optionally a vertical cross-section of the first bearing surface has a first shape, and a vertical cross-section of the second bearing surface has a second shape that is different than the first shape.

The inking assembly optionally includes one or more of the previous embodiments, and may further comprise a third spacer interconnected to third cylindrical body of the form roller. The third spacer comprises a third bearing surface selectively engageable with the first bearing surface to define a second gap between the first cylindrical body and the third cylindrical body.

Yet another aspect of the disclosure is a decorator configured to decorate an exterior surface of a metallic container, comprising: (1) an inking assembly, comprising: (a) an ink fountain configured to provide a supply of ink; (b) an ink roller to receive ink from the ink fountain; (c) an ink train comprising a plurality of cylindrical rollers to transfer ink from the ink roller to a form roller, the form roller comprising a first spacer with a first bearing surface; and (d) a plate cylinder comprising a printing plate with a decoration adapted to receive ink from the form roller, the plate cylinder comprising a second spacer with a second bearing surface selectively engageable with the first bearing surface of the first spacer such that the first and second spacers set a distance between the form roller and the plate cylinder; and (2) a blanket wheel comprising a transfer blanket adapted to receive ink from the printing plate.

In some embodiments, the blanket wheel may optionally comprise a third spacer with a third bearing surface selectively engageable with the second bearing surface of the second spacer of the plate cylinder. In this manner, the second and third spacers set a distance between the plate cylinder and the blanket wheel.

The decorator optionally includes one or more of the previous embodiments, and the form roller optionally comprises a first cylindrical body with a first diameter and the first bearing surface of the first spacer has a first spacer diameter.

In some embodiments, the first spacer diameter is less than the first diameter. Alternatively, in other embodiments, the first spacer diameter is equal to the first diameter. In still other embodiments, the first spacer diameter is greater than the first diameter.

The decorator optionally includes one or more of the previous embodiments, and in some embodiments the plate cylinder comprises a second diameter and the second bearing surface of the second spacer has a second spacer diameter.

In at least one embodiment, the second spacer diameter is less than the second diameter. Alternatively, the second spacer diameter is equal to the second diameter. Optionally, in other embodiments, the second spacer diameter is greater than the second diameter.

The decorator optionally includes one or more of the previous embodiments, and optionally the first spacer diameter is greater than the first diameter and the second spacer diameter is greater than the second diameter. Alternatively, the first spacer diameter is greater than the first diameter and the second spacer diameter is less than the second diameter. In still other embodiments, the first spacer diameter is less than the first diameter and the second spacer diameter is greater than the second diameter.

The decorator optionally includes one or more of the previous embodiments, and in some embodiments the blanket wheel comprises a third diameter and the third bearing surface of the third spacer has a third spacer diameter.

In at least one embodiment, the third spacer diameter is less than the third diameter. Alternatively, the third spacer diameter is equal to the third diameter. Optionally, in other embodiments, the third spacer diameter is greater than the third diameter.

In some embodiments, contact of the first bearing surface with the second bearing surface creates a first gap between a first cylindrical body of the form roller and a second cylindrical body of the plate cylinder

The decorator optionally includes one or more of the previous embodiments, and in some embodiments, the first gap has a first magnitude of between about 0.01 and about 0.2 inches.

Optionally, the first magnitude of the first gap is adjustable.

In at least one embodiment, one or more of the first spacer and the second spacer are removably affixed to the associated form roller and plate cylinder. Optionally, a replacement first spacer and a replacement second spacer are attachable to the form roller and the plate cylinder to alter the first magnitude of the first gap.

The decorator optionally includes one or more of the previous embodiments, and in one or more embodiments the blanket wheel comprises a third spacer with a third bearing surface selectively engageable with the second bearing surface of the second spacer of the plate cylinder. In this manner, contact of the third bearing surface with the second bearing surface creates a second gap between a third cylindrical body of the blanket wheel and the second cylindrical body of the plate cylinder

In at least one embodiment the second gap has a second magnitude of between about 0.01 and about 0.2 inches.

In at least one embodiment, the first spacer is one of a pair of first spacers associated with the form roller.

In at least one embodiment, a first one of the pair of first spacers is associated with a first end of a first cylindrical body of the form roller, and a second one of the pair of first spacers is associated with a second end of the first cylindrical body of the form roller.

In at least some embodiments, the second spacer is one of a pair of second spacers associated with the plate cylinder.

Optionally, a first one of the pair of second spacers is associated with a first end of a second cylindrical body of the plate cylinder and a second one of the pair of second spacers is associated with a second end of the second cylindrical body of the plate cylinder.

The decorator optionally includes one or more of the previous embodiments, and in some embodiments the decorator further comprises a release mechanism operable to move one or more of the form roller, the plate cylinder, and the blanket wheel to separate one or more of the first and third bearing surfaces from the second bearing surface such that the plate cylinder is removable from the decorator.

These and other advantages will be apparent from this disclosure. The above-described aspects, embodiments, objectives, and configurations are neither complete nor exhaustive. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

As will be appreciated, other embodiments are possible using, alone or in combination, one or more of the features set forth above or described below. Further, the Summary is neither intended nor should it be construed as representing the full extent and scope of the present disclosure. As will be appreciated, other embodiments are possible using, alone or in combination, one or more of the features set forth above or described below. For example, it is contemplated that various features and elements shown and/or described with respect to one embodiment or figure may be combined with or substituted for features or elements of other embodiments or figures regardless of whether or not such a combination or substitution is specifically shown or described herein.

Although generally referred to herein as “metallic container,” “beverage container,” “aerosol container,” “can,” and “container,” it should be appreciated that the decorator of the current disclosure may be used to decorate containers with a generally cylindrical body of any size or shape including, without limitation, beverage cans, beverage bottles, beverage cups, and aerosol containers. Accordingly, the term “container” is intended to cover containers of any type or shape for any product and is not specifically limited to a beverage container such as a soft drink or beer can. The containers may also be in any state of manufacture and may be formed by a draw and ironing process or by an impact extrusion process. Thus, the decorator of the present disclosure may be used to decorate “a cup” that is subsequently formed into a finished container, a “bottle preform” that is subsequently formed into a metallic bottle, or a “tube” that is formed into an aerosol container body.

The terms “metal” or “metallic” as used hereinto refer to any metallic material that may be used to form a container, including without limitation aluminum, steel, tin, and any combination thereof. However, it will be appreciated that the apparatus and method of the present invention can be used in various forms and embodiments to decorate containers formed of any material, including paper, plastic, and glass.

The phrases “cylindrical component of a decorator” and “rotating component of a decorator” are used herein to refer to various cylindrical elements and rollers of a decorator, including one or more of a blanket wheel, a plate cylinder, a form roller, a transfer roller, an oscillator roller, a ductor roller, an ink roller, and others.

The phrases “at least one,” “one or more,” “or,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, ratios, ranges, and so forth used in the specification and claims are to be understood as being modified in all instances by the term “about” or “approximately”.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “about equal” or “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

The use of “engaged with” and variations thereof herein is meant to encompass any direct or indirect connections between components.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s).

FIG. 1 is a side elevation view of a prior art decorator;

FIG. 2 is a schematic view of a prior art inking assembly of a prior art decorator;

FIG. 3A is a top plan view of a portion of a prior art inking assembly showing a plate cylinder adjacent to a form roller;

FIG. 3B is another top plan view of the portion of the prior art inking assembly of FIG. 3A illustrating the plate cylinder improperly aligned with the form roller;

FIG. 4 is a perspective view of a portion of a decorator of the present disclosure that includes spacers associated with the blanket wheel, plate cylinders, and form rollers;

FIG. 5A is a schematic top plan view of a portion of the decorator of FIG. 4;

FIG. 5B is another schematic top plan view of a portion of a decorator according to other embodiments of the present disclosure;

FIG. 6 is a top perspective view of a portion of the decorator of FIG. 4;

FIG. 7A is a vertical cross-sectional view of portions of two spacers of an adjacent pair of spacers and illustrating bearing surfaces according to embodiments of the present disclosure, the bearing surfaces separated in the vertical dimension for clarity;

FIG. 7B is another vertical cross-sectional view of portions of two spacers of an adjacent pair of spacers and illustrating bearing surfaces according to another embodiment of the present disclosure, the bearing surfaces separated in the vertical dimension for clarity;

FIG. 7C is still another vertical cross-sectional view of portions of two spacers of an adjacent pair of spacers and illustrating bearing surfaces according to more embodiments of the present disclosure, the bearing surfaces separated in the vertical dimension for clarity;

FIG. 7D illustrates another vertical cross-sectional view of portions of two spacers of an adjacent pair of spacers and shows another embodiment of bearing surfaces of the present disclosure, the bearing surfaces separated in the vertical dimension for clarity;

FIG. 7E provides yet another vertical cross-sectional view of portions of two spacers of an adjacent pair of spacers and illustrating bearing surfaces according to other embodiments of the present disclosure, the bearing surfaces separated in the vertical dimension for clarity;

FIG. 7F is another vertical cross-sectional view of portions of two spacers of an adjacent pair of spacers and illustrates bearing surfaces according to some embodiments of the present disclosure, the bearing surfaces separated in the vertical dimension for clarity;

FIG. 8A illustrates a side elevation view of an adjustable spacer of the present disclosure, with the adjustable spacer in a first state with a first diameter;

FIG. 8B illustrates another side elevation view of the adjustable spacer of FIG. 8B with the adjustable spacer in a second state with a second diameter; and

FIG. 9 is a schematic view of a control system of the present disclosure.

The drawings may be, but are not necessarily, drawn to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

The following is a listing of components according to various embodiments of the present disclosure, and as shown in the drawings:

| Number | Component |
|---|---|
| 2 | Decorator |
| 4 | Conveyor |
| 4A | In-feed conveyor |
| 4B | Out-feed conveyor |
| 6 | Metallic container |
| 6A | Undecorated metallic container |
| 6B | Decorated metallic container |
| 8 | Support cylinder or transport wheel |
| 10 | Blanket cylinder or wheel |
| 11 | Segments of blanket wheel |
| 12 | Transfer blanket |
| 14 | Plate cylinder |
| 16 | Printing plate |
| 18 | Inking assembly of the prior art |
| 20 | Ink fountain |
| 22 | Ink |
| 24 | Ink (or “fountain”) roller |
| 26 | Ductor roller |
| 28 | First transfer roller |
| 30 | Second transfer roller |
| 32 | First oscillator roller |
| 34 | Third transfer roller |
| 36 | Fourth transfer roller |
| 38 | Second oscillator roller |
| 40A | First form roller |
| 40B | Second form roller |
| 42 | Varnish unit |
| 43 | Varnish roller |
| 44 | Frame of inking assembly |
| 46 | Axle of form roller |
| 48 | Axle of plate cylinder |
| 50 | Gap between rollers |
| 52 | Direction for removal of plate cylinder |
| 60 | Decorator |
| 62 | Blanket wheel (or blanket cylinder) |
| 64 | Cylindrical body of blanket wheel |
| 66 | Axle of blanket wheel |
| 68 | Axis of rotation of the blanket wheel |
| 70 | Segments of the blanket wheel |
| 72 | Transfer blanket |
| 74 | Blanket wheel spacer |
| 76 | First distance (difference between spacer diameter of the blanket |
| | wheel spacer and the diameter of the blanket wheel) |
| 78 | Inking assembly |
| 80 | Ink fountain |
| 82 | Ink |
| 84 | Ink train |
| 86 | Plate cylinder |
| 88 | Cylindrical body of plate cylinder |
| 90 | Axle of plate cylinder |
| 92 | Axis of rotation of a plate cylinder |
| 94 | Printing plate |
| 96 | Plate cylinder spacer |
| 98 | Second distance (difference between spacer diameter of the plate |
| | cylinder spacer and the diameter of the plate cylinder) |
| 100 | Form roller |
| 102 | Cylindrical body of form roller |
| 104 | Axle of form roller |
| 106 | Axis of rotation of a form roller |
| 108 | Form roller spacer |
| 110 | Third distance (difference between spacer diameter of the form |
| | roller spacer and the diameter of the form roller) |
| 112 | Adjacent pair of spacers |
| 114-1 | First spacer of an adjacent pair of spacers |
| 114-2 | Second spacer of an adjacent pair of spacers |
| 116 | Reference plane |
| 120 | Bearing surface of a spacer |
| 120-1 | First bearing surface |
| 120-2 | Second bearing surface |
| 122 | Projection of bearing surface |
| 124 | Recess, groove, or depression in bearing surface |
| 126 | Sensor |
| 128 | Gap |
| 128A | Gap between form roller and plate cylinder |
| 128B | Gap between plate cylinder and blanket wheel |
| 130 | Adjustable spacer |
| 132 | Section of adjustable spacer |
| 133 | Seam between spacer sections |
| 134 | Axis of adjustable spacer |
| 136 | Release mechanism |
| 140 | Control system |
| 142 | Bus |
| 144 | CPU |
| 146 | Input devices |
| 148 | Output devices |
| 150 | Storage devices |
| 152 | Computer readable storage media reader |
| 154 | Communications system |
| 156 | Working memory |
| 158 | Processing acceleration unit |
| 160 | Database |
| 162 | Network |
| 164 | Remote storage device/database |
| 166 | Operating system |
| 168 | Other code |
| 170 | Inner portion of spacer |
| 172 | Outer portion of spacer |
| 174 | Joint between inner and outer portions |
| X | First dimension (or axial dimension) |
| Y | Second dimension (lateral or radial dimension) |
| Z | Third dimension (or vertical dimension) |

### DETAILED DESCRIPTION

To acquaint persons skilled in the pertinent arts most closely related to the present disclosure, a preferred embodiment that illustrates the best mode now contemplated for putting the invention into practice is described herein by, and with reference to, the annexed drawings that form a part of the specification. Exemplary embodiments are described in detail without attempting to describe all of the various forms and modifications in which the invention might be embodied. As such, the embodiments described herein are illustrative, and as will become apparent to those skilled in the arts, may be modified in numerous ways within the scope and spirit of the disclosure.

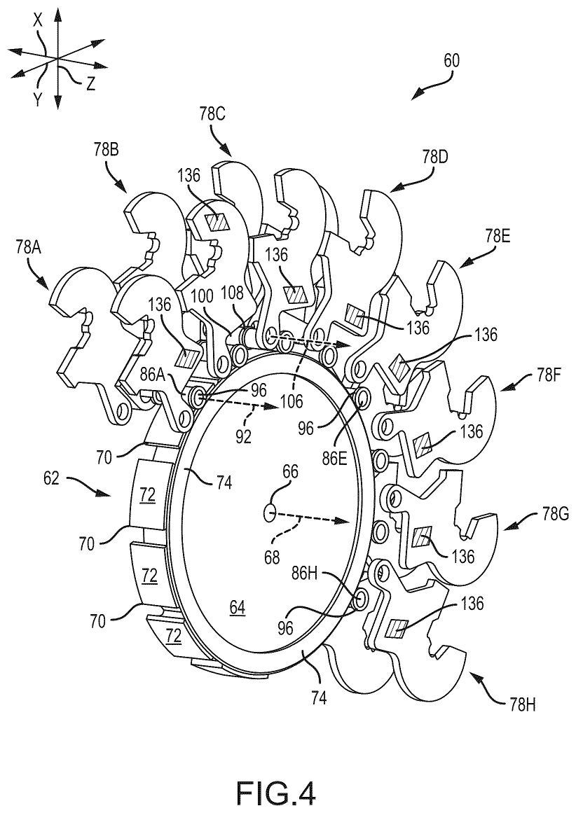

Referring now to FIGS. 4-6, a decorator 60 and associated components according to aspects of the present disclosure are generally illustrated. Portions of the decorator have been removed for clarity.

The decorator 60 is operable and configured to decorate objects that are generally cylindrical, such as metallic containers. The decorator generally comprises a blanket cylinder or wheel 62 with blanket segments 70 that are separated by gaps. Each blanket segment 70 includes a transfer blanket 72.

The decorator 60 has a plurality of inking assemblies 78 that each include an ink fountain 80 with a supply of ink 82. An ink train 84 of each inking assembly 78 includes cylindrical rollers (which may include one or more of an ink or fountain roller, a ductor roller, at least one transfer roller, an oscillator roller, and at least one form roller 100) which transfer the ink to a plate cylinder 86 with a printing plate 94.

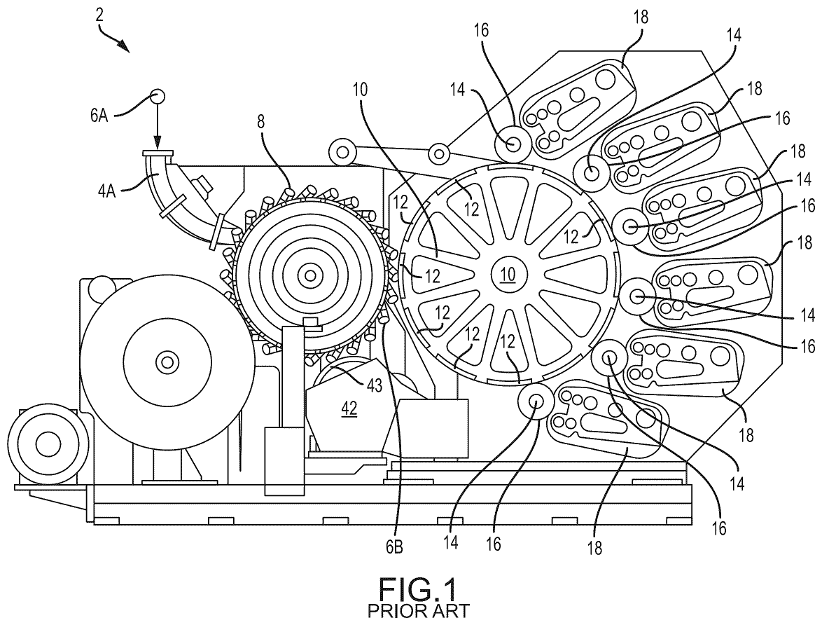

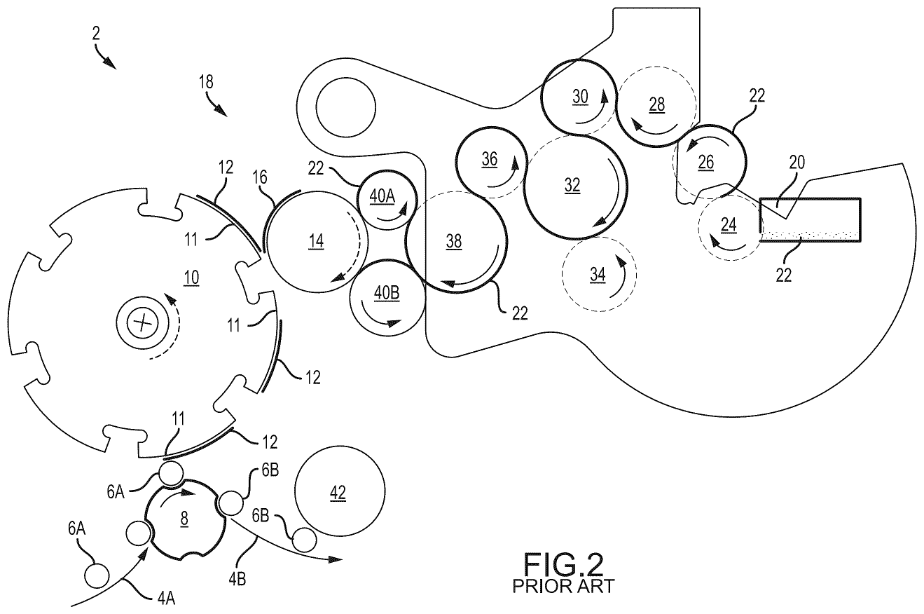

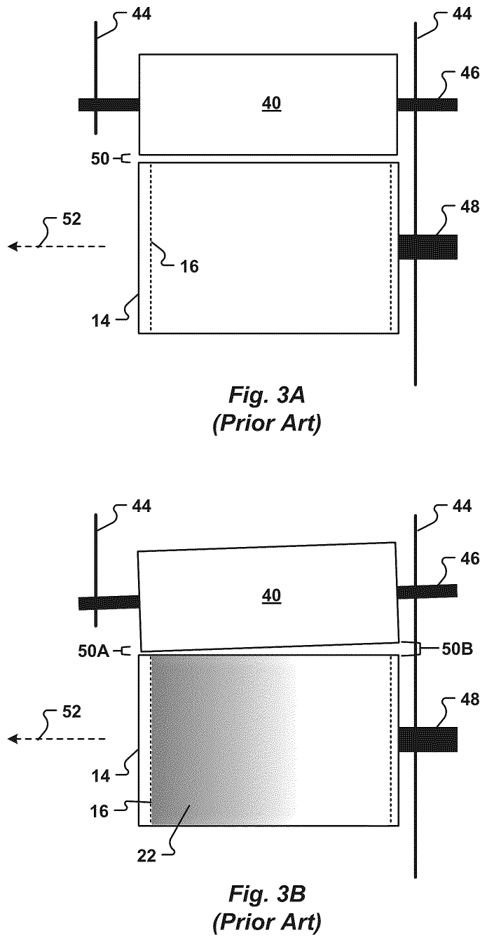

Similar to prior art decorators 2 for metallic containers, the transfer blankets 72 receive ink 82 from the printing plates 94 of one or more inking assembly 78, and the inks from the printing plates form an ink image on the transfer blankets 72. The transfer blankets subsequently transfer the ink image to a metallic container positioned on a support cylinder (not illustrated) the same as or similar to the support cylinder 8 illustrated in FIGS. 1-2.

Although the decorator 60 is illustrated in FIG. 4 with eight inking assemblies 78, the decorator may include any number of inking assemblies 78. In some embodiments the decorator may have three or four inking assemblies. Alternatively, the decorator 60 may include up to ten inking assemblies 78. In some embodiments, the decorator 60 has from three to ten inking assemblies.

Each inking assembly 78 may transfer a single color of ink to the printing plate 94 of a single associated plate cylinder 86. The printing plate 94 subsequently transfers ink to a transfer blanket 72 where the final lithographic ink image is formed.

As will be appreciated by one of skill in the art, during a production run, the decorator may operate with all of the inking assemblies 78 supplying inks to the transfer blankets, or only some of the inking assemblies supplying inks to the transfer blankets 72. Some decorations may require fewer colors of ink than the total number of inking assemblies. Accordingly, for some production runs, the decorator 60 may operate with some of its inking assemblies 78 disengaged (or even removed). For example, although a decorator 60 of the present disclosure may have ten inking assemblies 78, the decorator may operate and decorate metallic containers using only three inking assemblies 78 supplying three colors of ink to the transfer blankets 72 to form the decoration.

Notably, in contrast to the prior art decorator 2, the decorator 60 of the present disclosure optionally includes bearer bars or spacers 74, 96, 108 associated with two or more of the blanket wheel 62, the plate cylinders 86, and the form rollers 100. In some embodiments, the blanket wheel 62 and the plate cylinders 86 include spacers 74, 96 which engage each other. Additionally, or alternatively, in at least one embodiment, the plate cylinders 86 and form rollers 100 include spacers 96, 108 which engage each other.

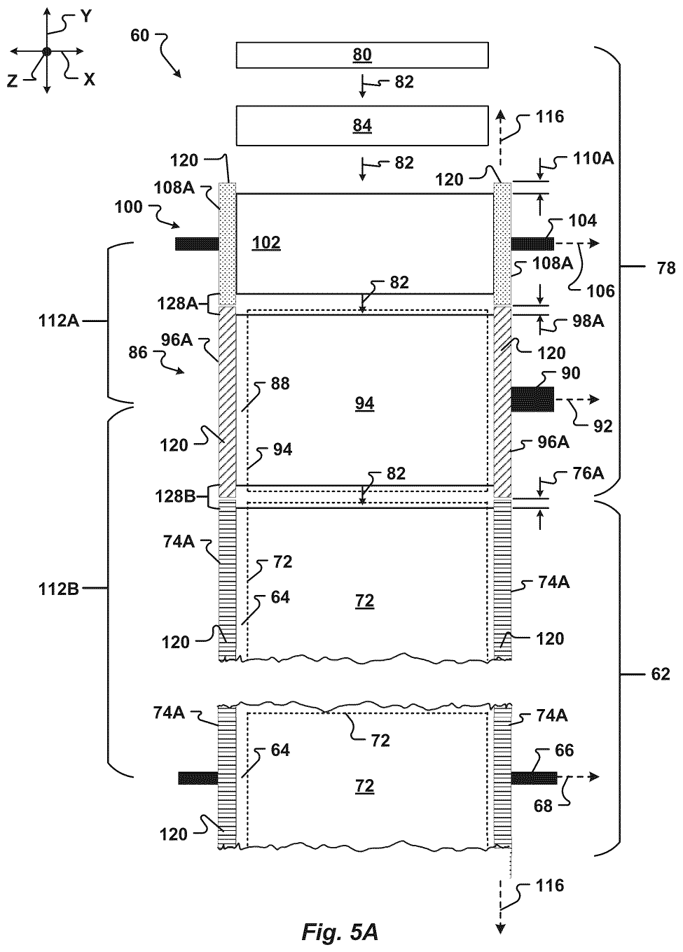

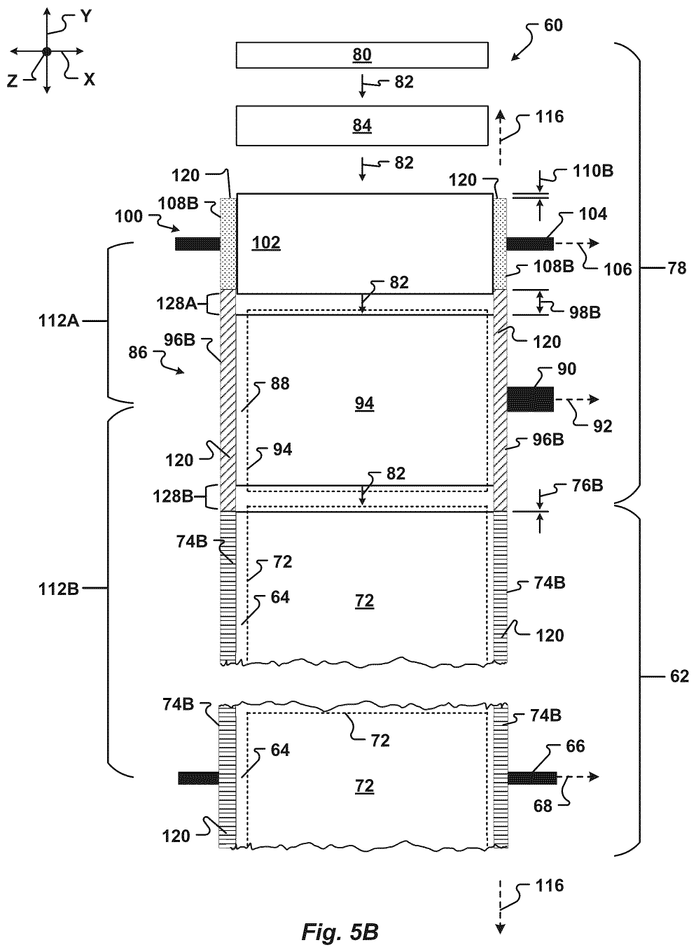

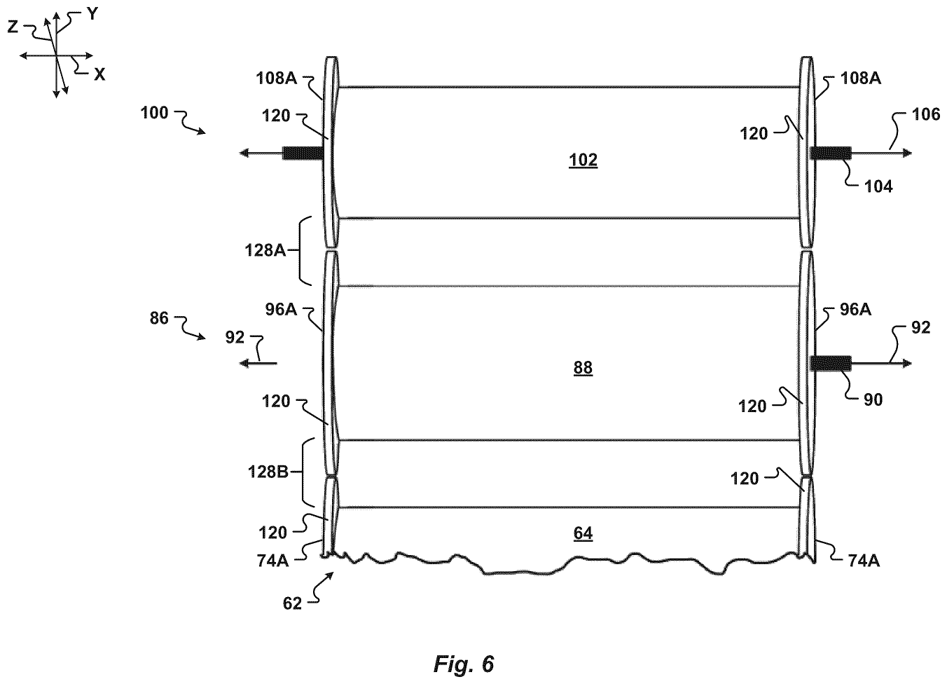

More specifically, the blanket wheel 62 may have at least one blanket wheel spacer 74. In some embodiments, the blanket wheel has two blanket wheel spacers 74 as generally illustrated in FIGS. 5A, 5B, and 6. Each spacer 74 may be proximate to an end of the blanket wheel 62.

Each plate cylinder 86 may also comprise at least one plate cylinder spacer 96. Optionally, each plate cylinder may have two plate cylinder spacers 96 as shown in the examples of FIGS. 5A, 5B, and 6. Similarly, each of the form rollers 100 optionally includes one or two form roller spacers 108.

The spacers 74, 96, 108 facilitate precise and consistent setting of the distance (and therefore the pressure) between the blanket wheel 62 (and its transfer blankets 72), the printing plates 94, and the form rollers 100. The distance and pressure consistency provided by the spacers allows for controlled and precise transfer of ink between the rotating cylindrical components of the decorator (i.e., from the form rollers 100 to the images of the printing plates 94, and from the printing plates to the transfer blankets 72). By achieving controlled pressure during ink transfer, the quality of decorations (which are related to pressure during ink transfer) can be consistently held to a high standard.

Much in the way that a railroad track bears the weight of the wheels of a locomotive, the bearer strips or spacers 74, 96, 108 can be installed on the circular or cylindrical rotating components (i.e., one or more of the blanket wheel 62, the plate cylinders 86, and the form rollers 100) of the decorator 60 to support the cylindrical components and set a distance or a gap 128 between two adjacent components.

Referring again to FIGS. 4-6, the spacers 74, 96, 108 of some embodiments can be visualized as discs or rings associated with two or more of the blanket wheel 62, plate cylinders 86, and form rollers 100. Adjacent spacers 74, 96 (and/or 96, 108) are oriented with their edges or bearing surfaces 120 facing each other. Adjacent spacers are positioned and aligned to make edge-to-edge contact.

In some embodiments, a first spacer (a form roller spacer 108 or a plate cylinder spacer 96) of a first one of the cylindrical components (a form roller 100 or a plate cylinder 86) will rest on (or engage) a second spacer (a plate cylinder spacer 96 or a blanket wheel spacer 74) of a second one of the cylindrical components (a plate cylinder 86 or the blanket wheel 62). In this manner, the first spacer will bear the weight of the second spacer. As will be appreciated, both spacers (the first and second spacers) are imparting the same amount of force onto one another as for every action there is an equal and opposite reaction.

To further expand upon this example, one can imagine two adjacent cylindrical components (a form roller 100 and a plate cylinder 86, or a plate cylinder 86 and the blanket wheel 62) as two metal spools. The edges (or bearing surfaces 120) of both discs on the first spool are resting atop the edges of the discs of the second spool. The first central cylinder of the first spool is a constant distance away from the second central cylinder of the second spool. The distance between the first and second central cylinders of the first and second spools is determined by the difference in radii of the discs of the first spool compared to the diameter of the first central cylinder plus the difference in radii of the discs of the second spool compared to the diameter of the second central cylinder. If, for example, one spool's end discs experience a reduction in diameter, then the first and second central cylinders of the first and second spools will move closer to one another. This concept is utilized in embodiments of the present disclosure to set a precise distance between at least some of the rotating cylindrical components of the decorator 60 to carefully and consistently control the distance between two rotational, cylindrical surfaces.

The addition of spacers 74, 96, 108 to the decorator beneficially constrains the motion of rotational pairs of components (i.e., a form roller 100 and a plate cylinder 86, or a plate cylinder 86 and the blanket wheel 62) such that the distance or gap 128 between each of these rotating components remains constant during operation of the decorator 60. Since the gap 128 between each rotational pair remains constant due to the pressure being borne by the spacers 74, 96, 108, more-consistent amounts of pressure will be encountered during component-to-component contact moments during ink transfer when the decorator 60 is in operation. As will be appreciated by one of skill in the art, the gap 128A between the form roller and the plate cylinder and the gap 128B between the plate cylinder and the blanket wheel have been exaggerated in FIGS. 5A, 5B and 6 for clarity.

The blanket wheel 62 has a body 64 that is generally cylindrical. The cylindrical body 64 has a cylindrical surface, a first end and an opposite second end. In some embodiments, the first and second ends are approximately orthogonal to an axis 68 of the blanket wheel. As generally illustrated in FIGS. 5A, 5B, one blanket wheel spacer 74 is optionally associated with (or positioned proximate to) the first end of the cylindrical body 64. Additionally, or alternatively, another blanket wheel spacer 74 is optionally associated with (or positioned proximate to) the second end of the cylindrical body 64.

In some embodiments, the blanket wheel spacer 74 is a ring. Alternatively, in other embodiments, the blanket wheel spacer 74 is a disc.

The plate cylinder 86 also has a body 88 that is generally cylindrical, and the cylindrical body 88 has a cylindrical surface, a first end and an opposite second end. In some embodiments, the first and second ends are optionally approximately orthogonal to an axis 92 of the plate cylinder. One plate cylinder spacer 96 may be associated with (or positioned proximate to) the first end of the cylindrical body 88. Additionally, or alternatively, another plate cylinder spacer 96 is optionally associated with (or positioned proximate to) the second end of the cylindrical body 88 of the plate cylinder 86.

The form roller 100 has a body 102 that is generally cylindrical. The cylindrical body 102 of the form roller has a cylindrical surface, a first end and an opposite second end. In some embodiments, optionally the first and second ends are approximately orthogonal to an axis 106 of the form roller. One form roller spacer 108 may optionally be associated with (or positioned proximate to) the first end of the cylindrical body 102. Additionally, or alternatively, another form roller spacer 108 is optionally associated with (or positioned proximate to) the second end of the cylindrical body 102 of the form roller.

In some embodiments one or more of the spacers 74, 96, 108 are removably affixed to the respective blanket wheel 62, plate cylinder 86, and form roller 100. In this manner, one or more of the spacers 74, 96, 108 may optionally be removed and replaced with a spacer of a different diameter, or for maintenance.

Optionally, at least one of the spacers 74, 96, 108 is integrally formed with an end of an associated cylindrical body 64, 88, 102 of the respective blanket wheel 62, plate cylinder 86, and form roller 100. In some embodiments, a spacer 74, 96, 108 is integral to an associated blanket wheel 62, plate cylinder 86, or form roller 100. For example, in some embodiments, a bearing surface 120 is formed on one or more of a blanket wheel 62, a plate cylinder 86, and a form roller 100 by removal of existing material on an existing portion of the blanket wheel, plate cylinder, or form roller. In at least one embodiment, the bearing surface 120 may be a surface on one edge or end of a blanket wheel 62, plate cylinder 86, or form roller 100 that is machined to a predetermined diameter to form the spacer 74, 96, 108 and its bearing surface. The bearing surface 120 may then be aligned radially with a corresponding spacer of an adjacent one of the blanket wheel 62, plate cylinder 86, or form roller 100. Thus, in some embodiments, the spacer 74, 96, 108 may form (or be part of) an end of the wheel, cylinder or roller as well as defining a bearing surface 120. Accordingly, in at least some embodiments, a spacer 74, 96, 108 may not be separatable or removable from an associated blanket wheel 62, plate cylinder 86, or form roller 100.

The spacers 74, 96, 108 may be of any size or shape. In some embodiments one or more of the spacers 74, 96, 108 comprises a body that may be described as a disc or a ring.

The spacers 74, 96, 108 may be formed of any suitable material known to those of skill in the art. The material may be substantially dimensionally stable. Optionally, all of the spacers 74, 96, 108 are formed of the same material. In at least one embodiment, the blanket wheel spacer 74 is formed of a first material, the plate cylinder spacers 96 are formed of one of the first material and a second material, and the form roller spacers 108 are formed of one of the first material, the second material, and a third material.

In some embodiments, one or more of the spacers 74, 96, 108 is formed of a metal, a ceramic, a polymeric material (such as nylon, plastic), and combinations thereof. In some embodiments, the spacers 74, 96, 108 are formed of a steel.

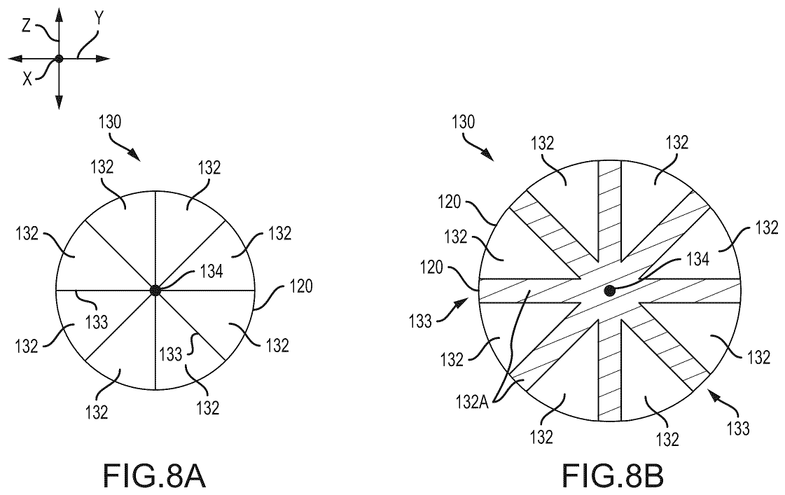

One or more of the spacers 74, 96, 108 may optionally be formed of a single piece of material. Alternatively, and referring now to FIG. 8, in some embodiments, at least one of the spacers 74, 96, 108 is formed of two or more pieces of material. For example, a spacer may comprise multiple portions or sections 132. In some embodiments, at least a first one of the sections 132 is moveable relative to at least a second one of the sections 132. In this manner, a size or diameter of the spacer 74, 96, 108 may be altered.

One or more of the spacers 74, 96, 108 may comprise a rotatable member. For example, in some embodiments, an adjacent pair of rotating components (such as the blanket wheel 62 and the plate cylinder 86, and/or the plate cylinder and a form roller 104) may comprise a first spacer 74, 96, 108 comprising a disc or a ring and a second spacer 74, 96, 108 comprising one or more rotatable members that engage a bearing surface 120 of the first spacer. The rotatable members may comprise rollers, wheels, ball bearings and the like.

The second spacer may optionally comprise one or more bearing assemblies configured to engage the first spacer. For example, the bearing assembly may be similar to a wheel assembly of a roller coaster car.

In some embodiments, the bearing assembly of the second spacer comprises a first rotatable member to engage the bearing surface 120 of the first spacer. Optionally, the bearing assembly may comprise a second rotatable member to engage another portion of the first spacer. The second rotatable member may optionally engage an end of the first spacer, with the end oriented approximately perpendicular to the bearing surface 120. Accordingly, the second rotatable member is similar to a side-friction wheel of a wheel assembly of a roller coaster car.

Additionally, or alternatively, the bearing assembly of the second spacer may comprise a third rotatable member spaced from the first rotatable member. In some embodiments, the third rotatable member is configured to engage a surface of the first spacer opposite to the bearing surface 120. For example, the third rotatable member may be positioned radially inward of the first rotatable member similar to an up-stop wheel of the wheel assembly of the roller coaster car.

Referring now to FIGS. 5A, 5B, and 6, the spacers 74, 96, 108 are illustrated enlarged compared to the blanket wheel 62, a plate cylinder 86, and a form roller 100 for clarity. Only a portion of the blanket wheel 62 is illustrated in FIGS. 5A-6. In some embodiments, the spacers 74, 96, 108 are generally circular when viewed from a first or axial dimension X, and may be described as generally disc or ring shaped. Other shapes of the spacers 74, 96, 108 are contemplated.

In some embodiments, the bearing surfaces 120 of the spacers 74, 96, 108 are substantially cylindrical. For example, in at least one embodiment, the bearing surfaces 120 of one or more of the spacers has an eccentricity of approximately 0. In at least one embodiment, one or more of the bearing surfaces 120 has an eccentricity of from 0 to 0.1. In some embodiments, one or more of the bearing surfaces 120 has an eccentricity of from 0 to 0.01. In other embodiments, one or more of the bearing surfaces 120 of the spacers 74, 96, 108 has an eccentricity of from 0 to 0.005.

The spacers 74, 96, 108 of one or more embodiment have a thickness measured in the axial dimension X and a spacer diameter measured in a radial dimension Y that is orthogonal to the first dimension X. In some embodiments, the spacer diameter is at least five times greater than the spacer thickness.

The spacer diameter of each of the spacers 74, 96, 108 may be less than, equal to, or greater than a diameter of the associated cylindrical body 64, 88, 102 of the respective blanket wheel 62, plate cylinder 86, and form roller 100. The one-half of the difference between a spacer diameter and the diameter of an associated cylindrical body 64, 88, 102 defines a first distance 76, a second distance 98, and a third distance 110 which are described in conjunction with FIGS. 5A and 5B.

For example, and referring now to FIG. 5A, in some embodiments, the spacer diameter of the blanket wheel spacer 74A is at least about 0.001 inches greater than the diameter of the cylindrical body 64 of the blanket wheel 62. Said differently, the blanket wheel spacer 74A optionally extends radially away from the cylindrical body 64 of the blanket wheel 62 by a predetermined first distance 76A of at least about 0.0005 inches.

Optionally, the first distance 76A is between about 0.0005 and about 0.1 inches. In some embodiments, the first distance 76A is between about 0.003 and about 0.04 inches. Other diameters of the blanket wheel spacer 74 are contemplated to provide different magnitudes for the first distance 76A.

Similarly, in some embodiments the spacer diameter of the plate cylinder spacer 96A is optionally greater than the diameter of the cylindrical body 88 of the plate cylinder 86. Accordingly, the plate cylinder spacer 96 optionally extends radially a predetermined second distance 98A (illustrated in FIG. 5A) away from the cylindrical body 88 of the plate cylinder.

The second distance 98A may optionally be the same as the first distance 76A. Alternatively, the second distance 98A is different than the first distance 76A.

In some embodiments, the second distance 98A is at least about 0.0005 inches. In at least one embodiment, the second distance 98A is between about 0.0005 and about 0.1 inches. Optionally, the second distance 98A is between about 0.003 and about 0.04 inches. Other diameters of the plate cylinder spacer 96A are contemplated to provide different magnitudes for the second distance 98.

Similarly, the spacer diameter of the form roller spacer 108A is optionally greater than the diameter of the cylindrical body 102 of the form roller 100 in at least one embodiment such that the form roller spacer 108A optionally extends radially a predetermined third distance 110A (illustrated in FIG. 5A) away from the cylindrical body 102 of the form roller 100.

The third distance 110A may optionally be the same as one or more of the first distance 76A and the second distance 98A. Alternatively, the third distance 110A is different than one or more of the first and second distances 76A, 98A.

In some embodiments, the third distance 110A is at least about 0.0005 inches. In at least one embodiment, the third distance 110A is between about 0.0005 and about 0.1 inches. Optionally, the third distance 110A is between about 0.003 and about 0.04 inches. Other diameters of the form roller spacer 108A are contemplated to provide different magnitudes for the third distance 110A.

Alternatively, and referring now to FIG. 5B, in some embodiments the diameter of one or more of the spacers 74, 96, 108 is less than (or equal to) the diameter of the associated cylindrical body 64, 88, 102 of the respective blanket wheel 62, plate cylinder 86, and form roller 100. More specifically, as generally illustrated in FIG. 5B, the blanket wheel 62 includes one or more blanket wheel spacers 74B which have spacer diameters that are approximately equal to the diameter of the cylindrical body 64 of the blanket wheel 62. Accordingly, the first distance 76B (i.e., one-half of the difference between the blanket wheel diameter and the spacer diameters of the blanket wheel spacers) is approximately zero inches.

Other magnitudes of the first distance 76B are contemplated. For example, in some embodiments, the blanket wheel spacers 74B have diameters that are less than the diameter of the cylindrical body 64 of the blanket wheel 62 (similar to the form roller spacers 108B illustrated in FIG. 5B).

FIG. 5B also illustrates a form roller 100 with form roller spacers 108B that have diameters which are less than a diameter of the cylindrical body 102 of the form roller. Accordingly, the bearing surfaces of the form roller spacers 108B are recessed axially relative to the cylindrical body 102 of the form roller 100 by a third distance 110B (i.e., one-half of the difference between the form roller diameter and the spacer diameters of the form roller spacers). In this example, the third distance 110B may be expressed as a negative number.

In some embodiments, when the diameter of the form roller spacers 108B is less than the diameter of the cylindrical body 102, the third distance 110B may be between about 0.0005 inches and 0.1 inches. Optionally the third distance may be between about 0.003 inches and about 0.04 inches.

Other magnitudes of the third distance 110B are contemplated. For example, in some embodiments, the form roller spacers 108B have diameters that are about equal to the diameter of the cylindrical body 102 of the form roller (similar to the blanket wheel spacers 74B illustrated in FIG. 5B).

Although FIG. 5B illustrates the plate cylinder spacers 96B with a diameter greater than the diameter of the cylindrical body 88 of the plate cylinder, in other embodiments the plate cylinder spacers have diameters that are approximately equal to the diameter of the cylindrical body 88 of the plate cylinder. Alternatively, in some embodiments, the plate cylinder spacers have diameters that are less than the diameter of the cylindrical body 88.

Notably, in the embodiment illustrated in FIG. 5B, the magnitude of the second gap 128B between the plate cylinder and the blanket wheel is defined by the second distance 98B. More specifically, in this embodiment, the magnitude of the second gap 128B is equal to the magnitude of the second distance 98B.

The printing plates 94 have surfaces that receive ink 82 from the form rollers 100. The surfaces of the printing plates subsequently transfer ink to the transfer blankets 72 to form an ink image on the transfer blankets. In some embodiments, the surfaces of the printing plates are raised. The raised surfaces of the printing plates 94 typically have a height of up to approximately 0.028 inch from a substrate.

In some embodiments the spacers 96, 108 are configured to define a gap 128A between the cylindrical surface of a plate cylinder 86 and the cylindrical surface of a form roller 100 of up to about 0.2 inches. Optionally, in some embodiments, the gap 128A is between about 0.01 and about 0.04 inches. In other embodiments, the magnitude of the gap 128A is between about 0.012 and about 0.036 inches. Optionally, in at least one embodiment, the gap 128A is between about 0.013 and about 0.035 inches. In some embodiments, the gap 128A is not less than 0.028 inches. Other magnitudes of the gap 128A formed by spacers 96, 108 are contemplated.

Additionally, or alternatively, the spacers 74, 96 are configured to define a gap 128B between the cylindrical surface of the blanket wheel 62 and the cylindrical surface of a plate cylinder 86. Optionally, the gap 128B is approximately equal to the gap 128A.

In at least one embodiment, the gap 128B is different than the gap 128A. For example, in some embodiments the second gap 128B is greater than the first gap 128A. Alternatively, in other embodiments, the second gap 128B is less than the first gap 128A.

In some embodiments, the gap 128B is up to about 0.2 inches. Optionally, in some embodiments, the gap 128B is between about 0.01 and about 0.04 inches. In other embodiments, the magnitude of the gap 128B is between about 0.012 and about 0.036 inches. Optionally, in at least one embodiment, the gap 128B is between about 0.013 and about 0.035 inches. In some embodiments, the gap 128B is not less than 0.028 inches. The spacers 74, 96 may be configured to provide a gap 128B with other magnitudes.

In some embodiments, one or more of the gaps 128A, 128B are adjustable. For example, one or more of the spacers 74, 96, 108 is an adjustable spacer 130 which has a variable diameter (described in conjunction with FIGS. 8A, 8B). Additionally, or alternatively, a first spacer may optionally include multiple bearing surfaces 120 with different effective diameters. In this manner, one or more of the gaps 128A, 128B between adjacent cylindrical components may be altered by moving a bearing surface of an adjacent second spacer into contact with a selected bearing surface of the first spacer.

Moreover, in some embodiments the gaps 128A, 128B may be adjusted by removing one or more of a first blanket wheel spacer 74A, a first plate cylinder spacer 96A, and a first form roller spacer 108A. After removing one or more the first spacers 74A, 96A, 108A, a second blanket wheel spacer 74B, a second plate cylinder spacer 96B, and a second form roller spacer 108B are installed to replace the removed first spacers. The second spacers 74B, 96B, 108B have second diameters that are different than the first diameters of the first spacers 74A, 96A, 108A. Accordingly, by removing and replacing a spacer associated with one or more of the blanket wheel, the plate cylinder, and the form roller and replacing them with spacers that have a different diameter, the magnitude of the gaps 128A, 128B may be adjusted.

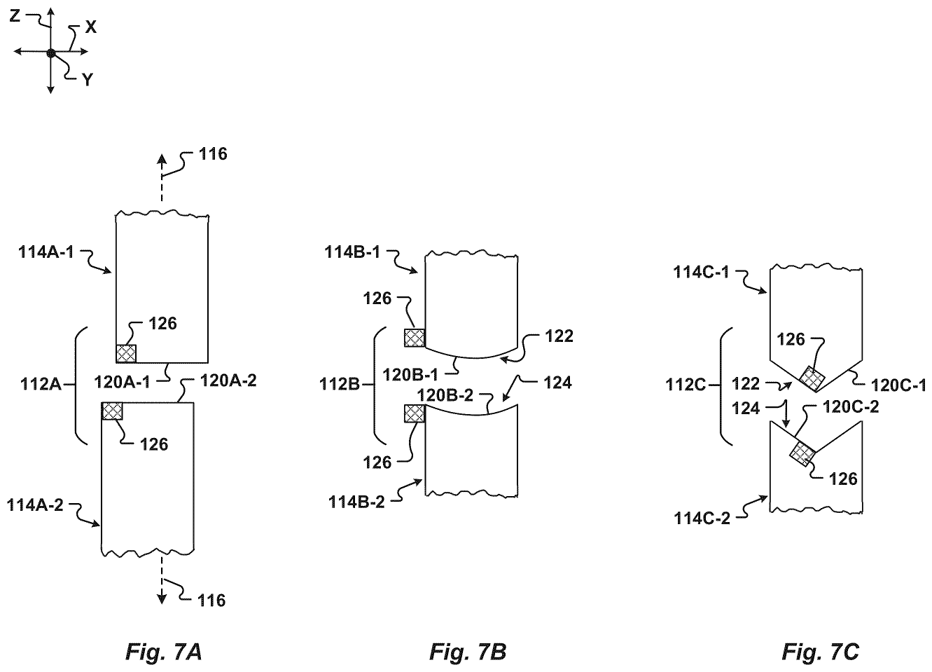

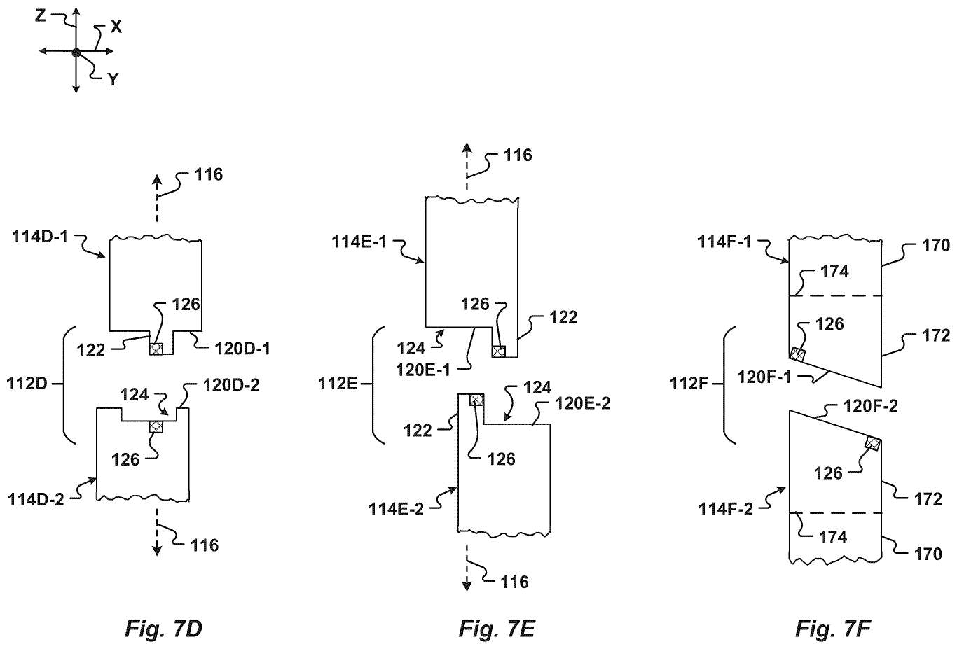

Referring now to FIGS. 7A-7F, adjacent pairs 112 of spacers 74, 96, 108 of various embodiments of the present disclosure are generally illustrated. The adjacent pairs 112 of spacers illustrated in each of FIGS. 7A-7F are drawn to scale relative to one another. However, the bearing surfaces 120-1, 120-2 of the spacers are illustrated spaced from one another for clarity and to accentuate the shapes of the bearing surfaces.

As generally shown, adjacent pairs 112 of spacers of all embodiments of the present disclosure may have complementary bearing surfaces 120. Specifically, a first spacer 114-1 of an adjacent pair 112 of spacers has a first bearing surface 120-1. A second spacer 114-2 of the adjacent pair 112 of spacers has a second bearing surface 120-2 configured to engage the first bearing surface of the first spacer.

The bearing surfaces 120 may have a variety of shapes when viewed in a cross-section taken along a vertical plane defined by the radial dimension X and a vertical or third dimension Z that is orthogonal to the axial and radial dimensions X, Y. In at least one embodiment, the first bearing surface 120A-1 is oriented approximately parallel to the axial dimension X as generally illustrated in FIG. 7A. In this embodiment, the second bearing surface 120A-2 is also oriented approximately parallel to the axial dimension X. In the example of FIG. 7A, the bearing surfaces 120A-1, 120A-2 are substantially identical.

The bearing surfaces 120A-1, 120A-2 beneficially facilitate movement of one or more of the first spacer 114A-1 and the second spacer 114A-2 of the adjacent pair 112A of spacers in the axial dimension X. Accordingly, as generally illustrated in FIG. 7A, the second spacer 114A-2 is not centered on the reference plane 116. The reference plane 116 extends in the radial dimension Y and the third dimension Z. In contrast, the first spacer 114A-1 is approximately centered on the reference plane 116.

Alternatively, in at least one embodiment, the first bearing surface 120-1 has a first shape and the second bearing surface 120-2 has a second shape such as generally illustrated in FIGS. 7B, 7C, 7D, 7E, and 7F. In some embodiments the first shape may be described as being keyed to the second shape (for example as illustrated in FIGS. 7B, 7C, and 7D). Additionally, or alternatively, the first shape may be described as being the inverse of the second shape as generally shown in FIGS. 7B, 7C, 7E, and 7F.

In some embodiments, the first shape is convex when the first bearing surface 120-1 is viewed in a cross-section of a first spacer 114-1 taken along the vertical plane extending in the axial and third dimensions X, Z and along a diameter of the spacer as generally illustrated in FIGS. 7B, 7C, and 7D. In these embodiments, the second shape of the second bearing surface 120-2 is concave.

Optionally, the second shape is rounded or “U-shaped” as generally shown in FIG. 7B. Alternatively, the second shape is “V-shaped” when viewed in the cross-section such as illustrated in FIG. 7C.

In some embodiments, the first bearing surface 120-1 has a projection 122 which extends from the first bearing surface in the third dimension Z in the embodiments illustrated in FIGS. 7B, 7C, 7D and 7E. In these embodiments, the second bearing surface 120-2 has a circumferential groove 124 or depression 124 configured to receive the projection 122.

In some embodiments, the groove or depression 124 has a depth that is greater than a height of the projection 122, the depth and the height both being measured in the third dimension Z. Alternatively, the groove or depression 124 may have a depth that is less than the height of the projection.

The bearing surfaces 120-1, 120-2 may also have shapes that provide a large tolerance between an adjacent pair 112 of spacers in the axial dimension X. For example, the embodiments illustrated in FIGS. 7A, 7D and 7E facilitate engagement between a first bearing surface 120-1 and a second bearing surface 120-2 even when the spacers 114A-1, 140A-2 are not centered along a reference plane 116 extending in the radial dimension Y and the third dimension Z.

In one or more embodiment, at least one of the first bearing surface 120-1 and the second bearing surface 120-2 is configured such that the gap 128A, 128B between the first rotating component and the second rotating component is adjustable. For example, in at least one embodiment generally illustrated in FIG. 7F, the first bearing surface 120-1F is sloped or angled toward the second bearing surface 120-2F. The second bearing surface 120-2F has a complementary shape that is sloped or angled away from the first bearing surface 120-1F.

In some embodiments, one or more of the spacers 74, 96, 108 are formed with a bearing surface 120 that is removable. More specifically, a spacer 74, 96, 108 may comprise an inner portion (for example, proximate to an axle 66, 90, 104 of an associated blanket wheel 62, plate cylinder 86, and form roller 100) and an outer portion that includes the bearing surface 120. Optionally, the outer portion with the bearing surface 120 may form a ring.

For example, as generally illustrated in FIG. 7F, spacers 114F-1, 114F-2 have an inner portion 170 proximate to an axle (not illustrated) and an outer portion 172 interconnected at a joint 174. Any suitable method known to those of skill in skill in the art may be used to interconnect the inner portion 170 and the outer portion 172. The outer portion 172 includes a bearing surface 120. The bearing surface 120 may have any appropriate shape or profile, including the shapes of the bearing surfaces 120A-120F described herein.

Forming a spacer with separate inner and outer portions 170, 172 beneficially permits the outer portion 172 to be removed for service. Moreover, a first outer portion 172 may be removed and replaced with a second outer portion 172 with a different diameter (or circumference) to alter a gap 128 between adjacent cylindrical components of the decorator. Additionally, or alternatively, a first outer portion 172 with a first bearing surface 120 comprising a first shape could be removed and replaced with a second outer portion 172 with a second bearing surface 120 comprising a second shape that is different than the first shape.

Referring again to FIGS. 5A, 5B, in some embodiments, the spacers 74, 96, 108 of adjacent pairs 112 of spacers are aligned approximately parallel to a reference plane 116 that extends in the radial and third dimensions Y, Z. As generally illustrated in FIGS. 5A, 5B, axes of rotation 68, 92, 106 of the respective blanket wheel 62, the plate cylinders 86 and the form rollers 100 are substantially parallel and approximately orthogonal to the reference plane 116.

In at least one embodiment, the spacers 74, 96, 108 do not move in the axial dimension X, at least during operation of the decorator 60. Accordingly, in some embodiments, the bearing surfaces 120 move relative to one-another in a static fashion, meaning the bearing surfaces do not slide across one another. More specifically, in some embodiments, the adjacent bearing surfaces 120 only rotate relative to each other and do not move in the axial dimension X when the decorator is in operation.

In some embodiments, one or more of the spacers 74, 96, 108 is fixed relative to the axle of an associated cylindrical component. More specifically, in some embodiments, one or more of the spacers 74, 96, 108 is mounted to its associated blanket wheel 62, plate cylinder 86, or form roller 100 such that the spacer cannot move in an axial direction (the X-dimension in the orientation of FIGS. 5A, 5B) relative to the associated axle.

Alternatively, in at least one embodiment, one or more of the spacers 74, 96, 108 may move in the axial dimension X during operation of the decorator 60. This may be beneficial for altering the magnitude of a gap 128A, 128B between adjacent cylindrical components of the decorator. Another benefit is that when a cylindrical component moves in the axial dimension X but the associated spacer 74, 96, 108 is already in a satisfactory alignment with respect to the reference plane 116, the spacer may be moved in the axial dimension X to realign the spacer with the reference plane 116. In this manner, the cylindrical component 62, 86, 100 may be moved in the axial dimension X, and then the associated spacer 74, 96, 108 may be moved in the axial dimension X along a respective axle 66, 90, 104 and into alignment with the reference plane 116 and/or an adjacent spacer.

In some embodiments, at least one of the spacers 74, 96, 108 is mounted to its associated cylindrical component 62, 86, 100 such that the spacer can move in the axial direction (i.e., in the first dimension X) relative to a cylindrical body 64, 88, 102 of the associated blanket wheel 62, plate cylinder 86, or form roller 100. This may be beneficial to ensure proper alignment between an adjacent pair 112 of spacers, or if it is necessary to align a printing plate 94 with a transfer blanket 72.

In one or more embodiments, the spacers 74, 96, 108 have a diameter that is constant. Accordingly, the bearing surface 120 of the spacers has a circumference that is constant, or that is not adjustable. In these embodiments, the spacers 74, 96, 108 are optionally formed of one piece of material. Thus, the spacers may be described as having a unitary construction, or being of one-piece. However, in other embodiments, a spacer 74, 96, 108 with a constant diameter may be formed of multiple elements, pieces of material, or sections.

Alternatively, and referring now to FIGS. 8A and 8B, in some embodiments, one or more of the spacers 74, 96, 108 is an adjustable spacer 130 that has a diameter that is adjustable. Accordingly, in a first state, the adjustable spacer 130 has a first diameter as generally illustrated in FIG. 8A. In the first state, the adjustable spacer has a circumference of a first magnitude.

Referring to FIG. 8B, in a second state the adjustable spacer 130 has a second diameter that is greater than the first diameter. The circumference is a second magnitude in the second state, the second magnitude being greater than the first magnitude.

Optionally, the adjustable spacer 130 may be formed of two or more pieces of material (or sections 132) that are configured to move to adjust the diameter. In some embodiments, the adjustable spacer includes a plurality of sections 132 that move relative to one another and to the axis 134 of the adjustable spacer 130.

The sections 132 may be separated by seams 133. However, in at least some embodiments, the bearing surface 120 remains unbroken (or substantially unbroken) in the first and second states. Accordingly, the bearing surfaces 120 of adjacent spacers may engage one another and provide a substantially constant gap 128 between associated rotating components of the decorator. The unbroken or substantially unbroken bearing surface 120 of the adjustable spacer 130 may also beneficially reduce inadvertent movement or vibration of associated rotating components (such as the blanket wheel 62, a plate cylinder 86, and/or a form roller 100).

In some embodiments, the unbroken bearing surface 120 is formed by the shape of the seam 133 extending in the axial dimension X. For example, the sections 132 (and the seams 133 between adjacent sections 132) may twist or bend as the sections extend in the axial dimension. Accordingly, a bearing surface of an adjacent spacer will span a seam 133 between sections 132 of the adjustable spacer as the spacer and the adjustable spacer rotate in contact with one another.

In some embodiments, the adjustable spacer includes one or more sections 132A adapted to at least partially fill the seams 133. As the sections 132 move to the second state generally illustrated in FIG. 8B, a section 132A may at least partially fill a seam 133 to provide a consistent (or unbroken) bearing surface 120.

Any suitable method or means known to those of skill in the art may be used to move the sections and to alter the diameter of the adjustable spacer 130 of the present disclosure. For example, in some embodiments, the diameter of the adjustable spacer 130 is expanded or contracted by linear or rotational methods. Additionally, or alternatively, sections 132 of the adjustable spacer 130 are configured to move to engage or disengage from another section 132 of the adjustable spacer. In some embodiments, an aperture-type motion is utilized. A piston-type linear actuation is optionally used in one or more embodiments to change the diameter of the adjustable spacer 130.

In some embodiments, the adjustable spacer may move from the first state to the second state as well as to any position in-between the first and second states. Thus, the adjustable spacer 130 may be adjusted to the first diameter, the second diameter, and any diameter between the first and second diameters.

In some embodiments the second diameter of the adjustable spacer 130 is at least 1 percent greater than the first diameter. Optionally, the second diameter is up to 20 percent greater than the first diameter. Additionally, or alternatively, the second diameter may be from 1 percent to 20 percent greater than the first diameter.

The adjustable spacer 130 advantageously allows the gaps 128A, 128B between adjacent pairs 112 of spacers to be adjusted. This is beneficial to account for wear of cylindrical components of the decorator 60, as well as to account for wear or damage to a printing plate or a transfer blanket.

In some embodiments, the adjustable spacer 130 may change between the first and second states during operation of the decorator 60. Alternatively, in other embodiments, the adjustable spacer 130 may only alter its diameter when the decorator is not in operation, such as before a production run.

Altering the size of the gaps 128A, 128B may also be beneficial (or necessary) to account for different thicknesses of transfer blankets 72 and printing plates 94. Specifically, the thickness of a transfer blanket or a printing plate may change due to wear from use. Moreover, transfer blankets and printing plates produced by different manufacturers may have different thicknesses that should be accounted for when setting the gaps 128A, 128B. The adjustable spacer 130 facilitates optimizing the size of the gaps 128A, 128B to account for changes in the thickness of the transfer blankets and printing plates due to manufacturing variability, damage, and wear.

To remove the plate cylinder 86 from the decorator 60, for example to change a printing plate 94, it may be necessary to disengage (or separate) one or more adjacent pairs 112 of spacers. As will be appreciated by one of skill in the art, when the decorator 60 is configured for a decoration run, a spacer 96 of a plate cylinder 86 may be engaged by one or more of a spacer 108 of a form roller 100 and the spacer 74 of the blanket wheel 62. It some embodiments of the decorator 60 of the present disclosure, it is beneficial to move one or more of the cylindrical components (the blanket wheel 62, the plate cylinder 86, and the form roller 100) in one or more dimensions X, Y, Z to increase the distance between their axles 66, 90, 104 so that the bearing surfaces 120 of one or more of the spacers 74, 96, 108 do not contact one another.

Referring again to FIG. 4, in some embodiments the inking assemblies 78 include a release mechanism 136. The release mechanism 136 facilitates release and removal of the plate cylinder 86 from the decorator when necessary to change a printing plate 94 for a new decoration, for servicing, due to damage, or any other reason.

In some embodiments, the release mechanism 136 is configured to lift or move all of (or a portion of) an inking assembly 78 away from one or more of the axle 90 of the plate cylinder 86 and the axle 66 of the blanket wheel 62. As will be appreciated by one of skill in the art, moving the entire inking assembly 78 is difficult due to: the weight of the inking assembly; its engagement to a frame of the decorator 60; and the close proximity of a first inking assembly to a second and/or third inking assembly.

In some embodiments, the release mechanism is operable to move at least a form roller 100 away from a plate cylinder 86. Additionally, or alternatively, the release mechanism may optionally alter the spacing between an axle 90 of the plate cylinder 86 and the axle 66 of the blanket wheel 62.

In embodiments, the release mechanism 136 is operable to move at least a portion of an inking assembly 78 (including the form roller 100) away from the plate cylinder 86. For example, the release mechanism 136 may be configured to move one or more of the inking assembly 78, the form roller 100, the plate cylinder 86, and the blanket wheel 62 in one or more of the axial dimension X, the radial dimension Y, and the third dimension Z.

In some embodiments, the release mechanism 136 is configured to move the axle 104 of the form roller 100 a predetermined distance away from the axle 90 of the plate cylinder 86. In some embodiments, the predetermined distance is at least about 0.1 inches. Additionally, or alternatively, the predetermined distance may be between about 0.1 inches and 3 inches. In some embodiments, the predetermined distance is between about 0.1 inches and 1.25 inches.

The release mechanism 136 of the present disclosure may utilize any means known to those of skill in the art to separate a plate cylinder 86 from other cylindrical components of the decorator. In some embodiments, the release mechanism utilizes helical motion to engage or disengage bearing surfaces 120 of an adjacent pair 112 of spacers. In this example embodiment, a sphere or hemisphere interlocked within a slot or channel is used to draw the spacers (or the cylindrical components) together when one of the components rotates.

Additionally, or alternatively, the release mechanism 136 optionally includes gears, pistons, worm drives, or other types of devices and means known to those of skill in the art to alter the distance between an axle 90 of a plate cylinder 86 and axles 66, 104 of one or more of the blanket wheel 62 and a form roller 100.

In some embodiments, the release mechanism may use an electrically actuated system to move one or more of the cylindrical components relative to one another. For example, the release mechanism may include a solenoid or motor to move.

The release mechanism 136 may optionally include a spring and/or magnets to alter the position of at least one of two cylindrical components of the decorator 60.

Referring again to FIGS. 7A-7F, one or more of the spacers 74, 96, 108 may optionally include a sensor 126. The sensor may be operable to collect a variety of data, including one or more of temperature, pressure, position in the X, Y and Z dimensions, movement (including a rate of rotation and/or vibration), stress, strain, and others. Any suitable sensor 126 known to those of skill in the art may be used with a spacer 74, 96, 108 of the present disclosure. For example, the sensor 126 may be optionally comprised of one or more of: a stress sensor; a strain sensor; a loadcell; a vision (or camera) system to measure position, movement or temperature; an ultrasonic sensor to measure distance; embedded fiber optic cables (such as a Bragg Structure); a laser; an electromagnetic measurement device; and an ultrasonic measurement device to measure one or more of the conditions mentioned herein.

When present, the sensor 126 may be used to determine the alignment of spacers 114-1, 114-2 of an adjacent pair 112 of spacers. More specifically, the sensor 126 may be operable to determine a position of one or more of the spacers 114-1, 114-2 in the X, Y and Z dimensions. The position may then be used to determine the position or alignment of the spacer with respect to the reference plane 116.

In some embodiments, the sensor may be used to determine the pressure or force applied to a bearing surface 120 of a spacer 114-1, 114-2. In this manner, excessive (or insufficient) force between an adjacent pair 112 of spacers can be identified.

The sensor 126 may also identify variations in the pressure between an adjacent pair 112 of spacers during a production run of the decorator 60. A variation in the pressure of the adjacent pair of spacers may indicate an axle 66, 90, 104 of one (or more) of the cylindrical components is not properly aligned in with the axial dimension X. Detection of a variation in pressure by the sensor may also indicate wear or damage to one of the cylindrical components and/or to a spacer 74, 96, 108. For example, a variation in pressure between an adjacent pair 112A, 112B of spacers may indicate vibration or other unintended movement of a cylindrical component of the decorator.

Another benefit of the sensor 126 is that it may be able to detect changes in operation or performance of the decorator 60 over time. For example, if a pressure detected by the sensor 126 between an adjacent pair 112 of spacers is substantially constant for a period of time but subsequently changes (i.e., increases or decreases), or fluctuates periodically, the variation in pressure may indicate one or more of the cylindrical components is worn or damaged.

The sensor 126 may be positioned proximate to the bearing surface 120 of one or more spacer 114-1, 114-2 of an adjacent pair 112 of spacers. In some embodiments, a sensor 126 is embedded in a spacer. Additionally, or alternatively, a sensor may be affixed to an exterior portion of a spacer.

In some embodiments, each spacer of an adjacent pair 112 of spacers includes a sensor 126. In some embodiments the sensors 126 of an adjacent pair of spacers may be aligned in a predetermined manner. For example, in some embodiments, the sensors 126 of an adjacent pair 112 of spacers are aligned in a similar manner relative to the reference plane 116.

In some embodiments, the sensors 126 can communicate with a control system 140. The sensors 126 may use any means known to those of skill in the art to transmit data to the control system.

In some embodiments, the sensors 126 use a wired connection to connect to the control system. Additionally, or alternatively, in at least one embodiment the sensors 126 can communicate using a wireless means with the control system. Optionally, the sensors 126 may connect to a wireless network. In some embodiments, the sensors use a Bluetooth system to connect to the control system.

The control system 140 may use information from the sensors 126 to monitor performance of the spacers 74, 96, 108 during operation of the decorator. In some embodiments, the control system 140 may use information from the sensors 126 to alter a gap 128A, 128B between two adjacent cylindrical components of the decorator. For example, in some embodiments the control system 140 may determine the gap 128A or 128B should be increased or decreased. In response, the control system 140 may send a signal to an actuator to adjust the gap 128A, 128B. In some embodiments, the control system 140 may send a signal to the release mechanism 136 to alter a position of one or more axles 66, 90, 104 of the decorator. Additionally, or alternatively, the control system 140 may send a signal to an adjustable spacer 130 to alter a diameter of the adjustable spacer.

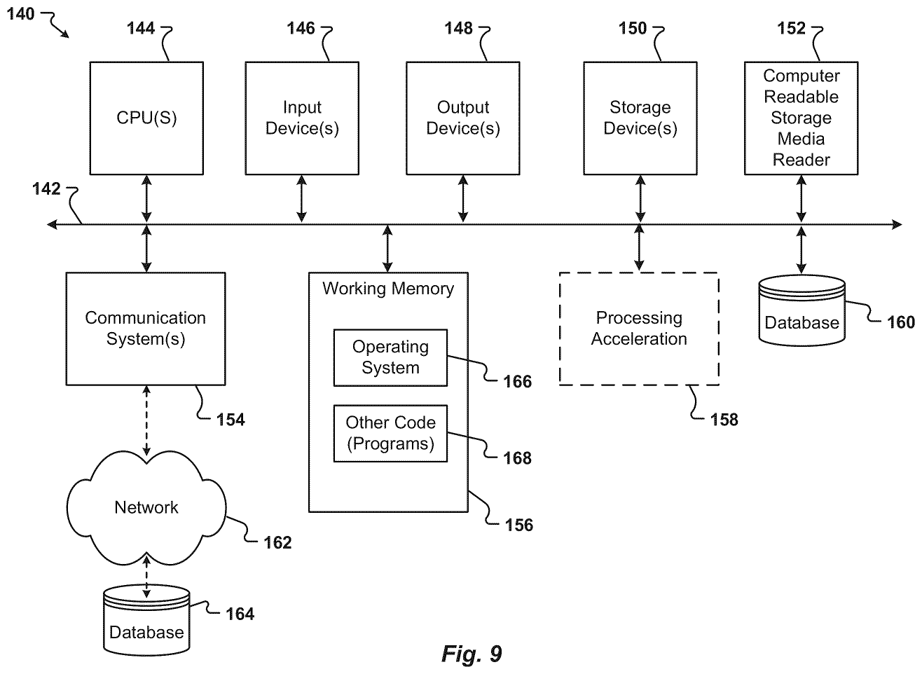

Referring now to FIG. 9, an embodiment of a control system 140 of the present disclosure is generally illustrated. More specifically, FIG. 9 illustrates one embodiment of a control system 140 of the present disclosure operable to control elements of the decorator 60 of the present disclosure. The control system 140 is generally illustrated with hardware elements that may be electrically coupled via a bus 142. The hardware elements may include one or more central processing units (CPUs) 144; one or more input devices 146 (e.g., a mouse, a keyboard, etc.); and one or more output devices 148 (e.g., a display device, a printer, etc.). The control system 140 may also include one or more storage devices 150. In one embodiment, the storage device(s) 150 may be disk drives, optical storage devices, solid-state storage device such as a random access memory (“RAM”) and/or a read-only memory (“ROM”), which can be programmable, flash-updateable and/or the like.

The control system 140 may additionally include one or more of a computer-readable storage media reader 152; a communications system 154 (e.g., a modem, a network card (wireless or wired), an infra-red communication device, etc.); and working memory 156, which may include RAM and ROM devices as described herein. In some embodiments, the control system 140 may also include a processing acceleration unit 158, which can include a DSP, a special-purpose processor and/or the like. Optionally, the control system 140 may also include a database 160.

The computer-readable storage media reader 152 can further be connected to a computer-readable storage medium, together (and, optionally, in combination with storage device(s) 150) comprehensively representing remote, local, fixed, and/or removable storage devices plus storage media for temporarily and/or more permanently containing computer-readable information. The communications system 154 may permit data to be exchanged with a network 162 and/or any other data-processing. Optionally, the control system 140 may access data stored in a remote storage device, such as database 164 by connection to the network 162. In one embodiment, the network 162 may be the internet.

The control system 140 may also comprise software elements, shown as being currently located within the working memory 156. The software elements may include an operating system 166 and/or other code 168, such as program code implementing one or more methods and aspects of the present invention.

One of skill in the art will appreciate that alternate embodiments of the control system 140 may have numerous variations from that described above. For example, customized hardware might also be used and/or particular elements might be implemented in hardware, software (including portable software, such as applets), or both. Further, connection to other computing devices such as network input/output devices may be employed.

In one embodiment, the control system 140 is a personal computer, such as, but not limited to, a personal computer running the MS Windows operating system. Optionally, the control system 140 can be a smart phone, a tablet computer, a laptop computer, and similar computing devices. In one embodiment, the control system 140 is a data processing system which includes one or more of, but is not limited to: at least one input device (e.g. a keyboard, a mouse, or a touch-screen); an output device (e.g. a display, a speaker); a graphics card; a communication device (e.g. an Ethernet card or wireless communication device); permanent memory (such as a hard drive); temporary memory (for example, random access memory); computer instructions stored in the permanent memory and/or the temporary memory; and a processor. The control system 140 may be any programmable logic controller (PLC). One example of a suitable PLC is a Controllogix PLC produced by Rockwell Automation, Inc., although other PLCs are contemplated for use with embodiments of the present invention.

The spacers 74, 96, 108 of all embodiments of the present disclosure provide a number of benefits. For example, the spacers 74, 96, 108 greatly increase the control of ink transfer during the decoration process compared to a similar, prior art decorator 2 that does not include spacers. For example, with the precise control of pressure provided by the spacers 74, 96, 108 of embodiments of the present disclosure, decorations with fine detail and small dot sizes are possible. Increasing the control of ink transfer also results in improved quality. The spacers 74, 96, 108 also improve the consistency of decorations produced by the decorator 60 of the present disclosure.

Another benefit is a reduction of wear to components of the decorator 60 (including the plate cylinders 86, the form rollers 100, and the transfer blankets 72) compared to the wear experienced by prior art decorators 2 due to excessive pressures or insufficient distances between rotational components being incorrectly set by operators. Specifically, the spacers 74, 96, 108 of the present disclosure ensure a gap 128A, 128B of a predetermined magnitude between two adjacent cylindrical components. The gaps 128A, 128B prevent application of excessive pressure to printing plates 94, the cylindrical body 102 of the form roller, and/or to the transfer blankets 72 and thus reduce friction, undue wear, and defects in decorations caused by the application of excessive ink and build-up of ink on the printing plates. Further, less friction and associated heat are generated by movement of the form roller relative to the plate cylinder, and due to movement of the plate cylinder relative to the blanket wheel.

The spacers 74, 96, 108 of the present disclosure also facilitate application of precise amounts of ink to each printing plate 94 (and subsequently to the transfer blankets 72) which beneficially reduces the amount of ink used or wasted, and reduces the number of decorated metallic containers rejected due deficient decorations. Still another benefit provided by the spacers 74, 96, 108 is a decrease in the amount of time required to set up the decorator 60 with new printing plates at the beginning of a decoration run.

Yet another benefit is that in embodiments in which the cylindrical components include two spacers (a first spacer proximate to a first end of a cylindrical body 64, 88, 102, and a second spacer proximate to a second end of the cylindrical body), the plate cylinders 86 will be supported at both ends in contrast to the prior art decorators 2 in which the plate cylinder 14 is only supported at one end. In these embodiments, supporting the plate cylinders 86 at both ends should reduce wear to the plate cylinder and bearings associated with the axle 90 of the plate cylinder resulting in longer life and less catastrophic down-time. In contrast, in prior art decorators, the bearings of an axle of a plate cylinder can wear out prematurely in a very short period of time if excessive head pressure is set by the operator. In embodiments in which the plate cylinders 86 have two spacers 96, the plate cylinders may also experience less vibration and inadvertent movement during a production run, further reducing decoration errors and improving decoration quality.

While various embodiments of the decorator of the present disclosure have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

The term “automatic” and variations thereof, as used herein, refer to any process or operation done without material human input when the process or operation is performed. However, a process or operation can be automatic, even though performance of the process or operation uses material or immaterial human input, if the input is received before the performance of the process or operation. Human input is deemed to be material if such input influences how the process or operation will be performed. Human input that consents to the performance of the process or operation is not deemed to be “material.”

The term “bus” and variations thereof, as used herein, can refer to a subsystem that transfers information and/or data between various components. A bus generally refers to the collection communication hardware interface, interconnects, bus architecture, standard, and/or protocol defining the communication scheme for a communication system and/or communication network. A bus may also refer to a part of a communication hardware that interfaces the communication hardware with other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

A “communication modality” can refer to any protocol or standard defined or specific communication session or interaction, such as Voice-Over-Internet-Protocol (“VOIP), cellular communications (e.g., IS-95, 1G, 2G, 3G, 3.5G, 4G, 4G/IMT-Advanced standards, 3GPP, WIMAX™, GSM, CDMA, CDMA2000, EDGE, 1×EVDO, iDEN, GPRS, HSPDA, TDMA, UMA, UMTS, ITU-R, and 5G), Bluetooth™, text or instant messaging (e.g., AIM, Blauk, eBuddy, Gadu-Gadu, IBM Lotus Sametime, ICQ, iMessage, IMVU, Lync, MXit, Paltalk, Skype, Tencent QQ, Windows Live Messenger™ or Microsoft Network (MSN) Messenger™, Wireclub, Xfire, and Yahoo! Messenger™), email, Twitter (e.g., tweeting), Digital Service Protocol (DSP), and the like.

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection of individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers to some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium,” as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, read only memory (ROM), a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. It should be noted that any computer readable medium that is not a signal transmission may be considered non-transitory.

The terms display and variations thereof, as used herein, may be used interchangeably and can be any panel and/or area of an output device that can display information to an operator or use. Displays may include, but are not limited to, one or more control panel(s), instrument housing(s), indicator(s), gauge(s), meter(s), light(s), computer(s), screen(s), display(s), heads-up display HUD unit(s), and graphical user interface(s).

The term “module” as used herein refers to any known or later developed hardware, software, firmware, artificial intelligence, fuzzy logic, or combination of hardware and software that is capable of performing the functionality associated with that element.

The terms “determine,” “calculate,” and “compute,” and variations thereof, as used herein, are used interchangeably and include any type of methodology, process, mathematical operation, or technique.

While the exemplary aspects, embodiments, options, and/or configurations illustrated herein show the various components of the system collocated, certain components of the system can be located remotely, at distant portions of a distributed network, such as a local area network (LAN) and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a private branch exchange (PBX) and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In one embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very-large-scale-integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or computer-generated imagery (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

What is claimed is:

1. A decorator configured to decorate an exterior surface of a metallic container, comprising:
an inking assembly, comprising:
an ink fountain configured to provide a supply of ink;
an ink roller to receive ink from the ink fountain;
an ink train comprising a plurality of cylindrical rollers to transfer ink from the ink roller to a form roller; and
a plate cylinder comprising a printing plate with a decoration adapted to receive ink from the form roller, the plate cylinder further comprising a first spacer with a first bearing surface; and
a blanket wheel comprising a transfer blanket adapted to receive ink from the printing plate, the blanket wheel further comprising a second spacer with a second bearing surface selectively engageable with the first bearing surface of the first spacer, wherein the first and second spacers set a distance between the plate cylinder and the blanket wheel.

2. The decorator of claim 1, wherein the form roller comprises a third spacer with a third bearing surface selectively engageable with the first bearing surface of the first spacer of the plate cylinder, wherein the first and third spacers set a distance between the form roller and the plate cylinder.

3. The decorator of claim 1, wherein the plate cylinder comprises a first cylindrical body with a first diameter and the first bearing surface of the first spacer has a first spacer diameter, and wherein:
the first spacer diameter is less than the first diameter;
the first spacer diameter is equal to the first diameter; or
the first spacer diameter is greater than the first diameter.

4. The decorator of claim 1, wherein contact of the first bearing surface with the second bearing surface creates a first gap between a first cylindrical body of the plate cylinder and a second cylindrical body of the blanket wheel, wherein the first gap has a first magnitude of between about 0.01 inches and about 0.2 inches.

5. The decorator of claim 4, wherein the form roller comprises a third spacer with a third bearing surface selectively engageable with the first bearing surface of the first spacer of the plate cylinder, wherein contact of the third bearing surface with the first bearing surface creates a second gap between a third cylindrical body of the form roller and the first cylindrical body of the plate cylinder, wherein the second gap has a second magnitude of between about 0.01 inches and about 0.2 inches.

6. The decorator of claim 1, wherein one or more of the first spacer and the second spacer is an adjustable spacer with a diameter that is variable.

7. The decorator of claim 1, wherein:
a vertical cross-section of the first bearing surface has a first shape; and
a vertical cross-section of the second bearing surface has a second shape that is different than the first shape.

8. The decorator of claim 1, wherein:
the first spacer is one of a pair of first spacers associated with the plate cylinder such that a first one of the pair of first spacers is associated with a first end of a first cylindrical body of the plate cylinder and a second one of the pair of first spacers is associated with a second end of the first cylindrical body of the plate cylinder; and
the second spacer is one of a pair of second spacers associated with the blanket wheel such that a first one of the pair of second spacers is associated with a first end of a second cylindrical body of the blanket wheel and a second one of the pair of second spacers is associated with a second end of the second cylindrical body of the blanket wheel.

9. The decorator of claim 1, wherein the plate cylinder comprises a first axle, and wherein the first spacer is immovable relative to the first axle.

10. The decorator of claim 1, further comprising a sensor operable to determine one or more of:
strain in one or more of the first and second spacers;
a rate of rotational movement of one or more of the first and second spacers;
vibration of one or more of the first and second spacers;
a pressure between the first and second bearing surfaces;
a temperature of one or more of the first and second bearing surfaces; and
a position of the first spacer relative to a vertical reference plane oriented perpendicular to an axle of the plate cylinder.

11. The decorator of claim 10, further comprising a control system operable to receive data from the sensor, wherein the control system is further operable to one or more of:
send a signal to an actuator to alter the position of the first spacer relative to the vertical reference plane; and
send a signal to one or more of the first spacer and the second spacer to alter a magnitude of a gap between a first cylindrical body of the plate cylinder and a second cylindrical body of the blanket wheel.

12. The decorator of claim 1, further comprising a release mechanism operable to move one or more of the form roller, the plate cylinder, and the blanket wheel to separate the second bearing surface from the first bearing surface such that the plate cylinder is removable from the decorator.

13. A method of controlling one or more of a pressure and a distance between two rotating cylindrical components of a decorator configured to apply a decoration to a cylindrical exterior surface of a metallic container, comprising:
providing an inking assembly of the decorator, comprising:
a form roller configured to receive ink from an ink fountain; and
a plate cylinder comprising a printing plate adapted to receive ink from the form roller, and a first spacer with a first bearing surface;
providing a blanket wheel of the decorator, the blanket wheel comprising a transfer blanket adapted to receive ink from the printing plate, and a second spacer with a second bearing surface selectively engageable with the first bearing surface of the first spacer;
setting a pressure between the first and second bearing surfaces;
transferring ink from the form roller to the printing plate;
transferring ink from the printing plate to the transfer blanket; and
transferring ink from the transfer blanket to the cylindrical exterior surface of the metallic container.

14. The method of claim 13, further comprising setting a first magnitude of a first gap between a first cylindrical body of the plate cylinder and a second cylindrical body of the blanket wheel, wherein the first gap is created by contact of the first bearing surface with the second bearing surface.

15. The method of claim 14, further comprising adjusting the first magnitude of the first gap by one or more of:
altering a diameter of the first spacer;
altering a diameter of the second spacer;
altering a position of the first spacer relative to the first cylindrical body of the plate cylinder;
altering a position of the second spacer relative to the second cylindrical body of the blanket wheel;
removing the first spacer and replacing it with a different first spacer with a different diameter than the first spacer; and
removing the second spacer and replacing it with a different second spacer with a different diameter than the second spacer.

16. The method of claim 13, further comprising collecting data with a sensor, the sensor operable to determine one or more of:
strain in one or more of the first and second spacers;
a rate of rotational movement of one or more of the first and second spacers;
vibration of one or more of the first and second spacers;
a pressure between the first and second bearing surfaces;
a temperature of one or more of the first and second bearing surfaces; and
a position of one or more of the first spacer and the second spacer relative to a vertical reference plane, the vertical reference plane oriented perpendicular to an axle of the plate cylinder.

17. The method of claim 13, further comprising providing a third spacer associated with the form roller, wherein the third spacer has a third bearing surface selectively engageable with the first bearing surface of the first spacer.

18. A decorator configured to decorate an exterior surface of a metallic container, comprising:
an inking assembly, comprising:
an ink fountain configured to provide a supply of ink;
an ink roller to receive ink from the ink fountain;
an ink train comprising a plurality of cylindrical rollers to transfer ink from the ink roller to a form roller, the form roller further comprising a first spacer with a first bearing surface; and
a plate cylinder comprising a printing plate with a decoration adapted to receive ink from the form roller, the plate cylinder further comprising a second spacer with a second bearing surface selectively engageable with the first bearing surface of the first spacer, wherein the first and second spacers set a distance between the form roller and the plate cylinder; and
a blanket wheel comprising a transfer blanket adapted to receive ink from the printing plate.

19. The decorator of claim 18, wherein the blanket wheel comprises a third spacer with a third bearing surface selectively engageable with the second bearing surface of the second spacer of the plate cylinder, wherein the second and third spacers set a distance between the plate cylinder and the blanket wheel.

20. The decorator of claim 18, wherein contact of the first bearing surface with the second bearing surface creates a first gap between a first cylindrical body of the form roller and a second cylindrical body of the plate cylinder, wherein the first gap has a first magnitude of between about 0.01 inches and about 0.2 inches.
